(19) United States
(12) Patent Application Publication
(10) Pub. No.: US 2026/0019502 A1
(43) Pub. Date: Jan. 15, 2026

(54) METHODS, NON-TRANSITORY COMPUTER-READABLE MEDIA AND ELECTRONIC DEVICES FOR PROCESSING CALL VOICE DATA

(71) Applicant: LINE Plus Corporation, Seongnam-si (KR)

(72) Inventors: Na Young KIM, Seongnam-si (KR); Keumryong KIM, Seongnam-si (KR)

(73) Assignee: LINE Plus Corporation, Seongnam-si (KR)

(21) Appl. No.: 19/267,812

(22) Filed: Jul. 14, 2025

(30) Foreign Application Priority Data
Jul. 15, 2024 (KR) 10-2024-0093007

(51) Int. Cl. H04M 3/42

(52) U.S. Cl. CPC H04M 3/42221

(57) ABSTRACT

A call voice data processing method performed by at least one processor, the call voice data processing method including converting first voice data into first text, the first voice data corresponding to a real-time call, first displaying the first text and first speaker information on a first screen, the first speaker information corresponding to a speaker of the first voice data, and second displaying second text and second speaker information on the first screen in response to receiving a first user input, the second text corresponding to second voice data associated with a first time point, the second voice data corresponding to the real-time call, the first time point being earlier than a current time by a first duration, and the second speaker information corresponding to a speaker of the second voice data.

### CROSS-REFERENCE TO RELATED APPLICATION

This application claims priority to Korean Patent Application No. 10-2024-0093007, filed in the Korean Intellectual Property Office on Jul. 15, 2024, the entire contents of which are hereby incorporated by reference.

### BACKGROUND

### Field

The present disclosure relates to call voice processing methods and electronic devices.

### Description of Related Art

Owing to advances in communication technology, technological development related to voice and video calls is actively in progress. For example, Voice over Internet Protocol (VOIP), which is evolving around the Internet as an integrated network environment, enables multiparty voice and video calls in which multiple users participate in addition to one-to-one voice and video calls. Through convergence with various fields such as Social Network Services (SNS) and games, VOIP is evolving into multiparty interactive immersive call technology that converts voices, music, and sounds input by multiple participants into spatial audio so that the participants may feel immersed.

Because a call involves transmission and reception of the voices of conversational participants in real time, a situation may arise in which a user misses a portion of a voice call. For example, a user may fail to hear the portion of the voice call because of an unexpected failure occurring during a call, or the user may fail to hear the portion of the voice call due to use of another application while multitasking during the call. If the user misses the portion of the voice call, the user may find it difficult to check past call content during the call because of the real-time nature of the call.

### SUMMARY

The present disclosure provides call voice processing methods and electronic devices that address challenges in voice calls by enabling past call content to be checked during a call or even when a screen has been switched, such as in a multitasking environment.

The present disclosure may be implemented in various forms including methods, apparatuses (systems), and/or non-transitory computer-readable recording media storing computer-readable instructions.

In some example embodiments, a call voice data processing method performed by at least one processor, the method may include converting first voice data into first text, the first voice data corresponding to a real-time call, first displaying the first text and first speaker information on a first screen, the first speaker information corresponding to a speaker of the first voice data, and second displaying second text and second speaker information on the first screen in response to receiving a first user input, the second text corresponding to second voice data associated with a first time point, the second voice data corresponding to the real-time call, the first time point being earlier than a current time by a first duration, and the second speaker information corresponding to a speaker of the second voice data.

In some example embodiments, the second displaying may include displaying information regarding the first time point together with the second text and the second speaker information on the first screen.

In some example embodiments, the first user input may include an input selecting a first object displayed on the first screen, or an input scrolling on the first screen in a first direction.

In some example embodiments, the call voice data processing method further includes displaying third text and third speaker information on the first screen in response to receiving a second user input, the third text corresponding to third voice data associated with a second time point, the second time point being later than the first time point, the third voice data corresponding to the real-time call, and the third speaker information corresponding to a speaker of the third voice data.

In some example embodiments, the call voice data processing method further includes third displaying third text and third speaker information based on satisfaction of at least one condition, the third text corresponding to third voice data associated with the current time, the third voice data corresponding to the real-time call, the third speaker information corresponding to a speaker of the of the third voice data, and the at least one condition includes passage of a second duration from the second displaying, or receiving a second user input.

In some example embodiments, the second user input may include an input selecting a second object displayed on the first screen, or an input scrolling on the first screen to an endpoint in a second direction opposite to the first direction.

In some example embodiments, the call voice data processing method further includes translating the first text into a first language set for a user based on a language set for the speaker of the first voice data differs from a language set for a recipient of the first voice data.

In some example embodiments, the second displaying may include displaying the second text and the second speaker information in a first area of the first screen, and the call voice data processing method further may include displaying third text and third speaker information in a second area of the first screen in response to receiving third voice data during the second displaying, the third text corresponding to the third voice data, the third voice data corresponding to the real-time call, the third speaker information corresponding to a speaker of the third voice data, and the second area being different from the first area.

In some example embodiments, the call voice data processing method further includes storing first log information of the real-time call based on the first text and the first speaker information.

In some example embodiments, the storing may include storing the first text the first speaker information after termination of the real-time call or in response to receiving a second user input.

In some example embodiments, the storing may include storing information regarding a time point of the first voice data along with the first text and the first speaker information.

In some example embodiments, the call voice data processing method further includes displaying the first log information on a second screen different from the first screen.

In some example embodiments, the call voice data processing method further includes displaying a third screen immediately after termination of the real-time call, the third screen including an object, and the displaying the first log information may further include displaying the first log information in response to receiving a second user input, the second user input including selection of the object.

In some example embodiments, the call voice data processing method further includes displaying a subset of the first text differently from a remainder of the first text within the first log information displayed on the second screen in response to receiving a second user input selecting the subset of the first text.

In some example embodiments, the call voice data processing method further includes determining whether a first user has subscribed to a first service, the storing being performed in response to determining the first user has subscribed to the first service.

In some example embodiments, the call voice data processing method further includes transmitting the first log information to an external electronic device in response to receiving a second user input.

In some example embodiments, the call voice data processing method further includes determining whether a second user of an external electronic device has subscribed to the first service, and determining whether to transmit the first log information to the external electronic device based on whether the second user has subscribed to the first service.

In some example embodiments, the call voice data processing method further includes transmitting second log information to the external electronic device in response to determining the second user has not subscribed to the first service, the second log information including a portion of the first log information, or information from the first log information converted into another format.

In some example embodiments, a non-transitory computer-readable storage medium storing computer-readable instructions that, when executed by at least one processor, cause the at least one processor to convert first voice data into first text, the first voice data corresponding to a real-time call, display the first text and first speaker information on a first screen of a display, the first speaker information corresponding to a speaker of the first voice data, and display second text and second speaker information on the first screen in response to receiving a first user input, the second text corresponding to second voice data associated with a first time point, the second voice data corresponding to the real-time call, the first time point being earlier than a current time by a first duration, and the second speaker information corresponding to a speaker of the second voice data.

In some example embodiments, an electronic device may include a display, memory, and at least one processor connected to the display and the memory, the at least one processor being configured to execute computer-readable instructions stored in the memory to cause the electronic device to convert first voice data into first text, the first voice data corresponding to a real-time call, display the first text and first speaker information on a first screen of the display, the first speaker information corresponding to a speaker of the first voice data, and display second text and second speaker information on the first screen in response to receiving a first user input, the second text corresponding to second voice data associated with a first time point, the second voice data corresponding to the real-time call, the first time point being earlier than a current time by a first duration, and the second speaker information corresponding to a speaker of the second voice data.

According to some example embodiments of the present disclosure, by displaying text obtained by converting the real-time call voice together with information about a speaker, real-time call content may be confirmed not only as voice information but also as visual information, thereby improving service quality for the call.

In addition, according to some example embodiments of the present disclosure, by displaying text obtained by converting past call voice and information about a speaker based on user input, it is possible to support the user in continuing a smooth conversation.

Further, according to some example embodiments of the present disclosure, by displaying text obtained by converting the real-time call voice and information about a speaker on a switched screen when the screen is switched, the user may easily confirm call content even in a multitasking environment.

The effects of the present disclosure are not limited to those mentioned above, and other effects not mentioned will be clearly understood by those of ordinary skill in the art from the description of the claims.

### BRIEF DESCRIPTION OF THE DRAWINGS

Some example embodiments of the present disclosure will be described with reference to the accompanying drawings described below, in which like reference numerals denote like elements, but are not limited thereto.

FIG. 1 illustrates an electronic device for processing call voice according to some example embodiments of the present disclosure.

FIG. 2 is a diagram illustrating a configuration in which an information processing system is connected so as to be able to communicate with multiple user terminals in relation to data processing according to some example embodiments of the present disclosure.

FIG. 3 is a block diagram illustrating internal configurations of a user terminal and an information processing system according to some example embodiments of the present disclosure.

FIG. 4 is a diagram illustrating a configuration of an electronic device for processing call voice according to some example embodiments of the present disclosure.

FIG. 5 is a diagram illustrating a method of displaying text obtained by converting call voice and information about a speaker on an execution screen of a call application according to some example embodiments of the present disclosure.

FIG. 6 is a diagram illustrating a method of processing real-time call voice while text obtained by converting past call voice and information about a speaker are displayed on an execution screen of a call application according to some example embodiments of the present disclosure.

FIG. 7 is a diagram illustrating a method of displaying text obtained by converting call voice and information about a speaker on another execution screen of a call application according to some example embodiments of the present disclosure.

FIG. 8 is a diagram illustrating a method of processing real-time call voice while text obtained by converting past call voice and information about a speaker are displayed on another execution screen of a call application according to some example embodiments of the present disclosure.

FIG. 9 is a diagram illustrating a method of displaying, in picture-in-picture form, text obtained by converting call voice and information about a speaker on an execution screen of an application other than the call application after a screen switch according to some example embodiments of the present disclosure.

FIG. 10 is a diagram illustrating a method of changing a size of a picture-in-picture area according to some example embodiments of the present disclosure.

FIG. 11 is a diagram illustrating a method of displaying text obtained by converting call voice and information about a speaker on an execution screen of a chat application linked with a call application according to some example embodiments of the present disclosure.

FIG. 12 is a diagram illustrating a method of processing sound corresponding to a specified pattern among call voice according to some example embodiments of the present disclosure.

FIG. 13 is a diagram illustrating a method of processing a call log according to some example embodiments of the present disclosure.

FIG. 14 is a diagram illustrating a method of displaying text obtained by converting past call voice and information about a speaker among a call voice processing method according to some example embodiments of the present disclosure.

FIG. 15 is a diagram illustrating a method of displaying text obtained by converting call voice and information about a speaker on a switched screen when the screen is switched among a call voice processing method according to some example embodiments of the present disclosure.

### DETAILED DESCRIPTION

Hereinafter, specific details for implementing the present disclosure will be described in detail with reference to the accompanying drawings. However, well-known functions or configurations will be omitted when they might unnecessarily obscure the gist of the present disclosure.

In the accompanying drawings, identical (or similar) or corresponding components are given identical (or similar) reference numerals. In the following description of examples, repetitive descriptions of identical (or similar) or corresponding components may be omitted. Even when a description of a component is omitted, such omission is not intended to indicate that the component is excluded from any example.

Advantages and features of some example embodiments, and methods for achieving them, will become clear with reference to the examples described below together with the accompanying drawings. However, the present disclosure is not limited to the examples disclosed herein and may be implemented in various different forms; the examples are merely provided so that the disclosure is complete and fully conveys the scope of the disclosure to those of ordinary skill in the art.

The terms used in this specification will be briefly explained, and the disclosed examples will be described in detail. Although general terms currently in wide use have been selected in consideration of functions in the present disclosure, meanings may vary according to the intention of those skilled in the art, precedent, or the emergence of new technology. Some terms may have been arbitrarily selected by the applicant; in such cases, the meanings will be described in detail in relevant portions of the description. Therefore, the terms used in the present disclosure should be defined based on the meanings and concepts thereof in consideration of the entire disclosure rather than simply on the names of the terms.

A singular expression in the specification includes a plural expression unless specifically stated to be singular in context, and likewise a plural expression includes a singular expression unless specifically stated to be plural in context. Throughout the specification, when a part “includes” a component, this does not exclude the presence of another component unless expressly stated otherwise, but means that another component may be further included.

The terms “module” or “unit” used in the specification denote software or hardware components that perform certain roles. However, the terms “module” or “unit” are not limited to software or hardware. A “module” or “unit” may reside in an addressable non-transitory storage medium and may be reproduced by one or more processors. Accordingly, for example, a “module” or “unit” may include at least one of software components, object-oriented software components, class components and task components, processes, functions, attributes, procedures, subroutines, program code segments, drivers, firmware, microcode, circuits, data, databases, data structures, tables, arrays, variables, etc. Functions provided by the components and “modules” or “units” may be combined into a fewer number of components and “modules” or “units,” or may be further divided into additional components and “modules” or “units.”

According to some example embodiments of the present disclosure, a “module” or “unit” may be implemented by processing circuitry. Processing circuitry should be broadly interpreted to include, for example, a general-purpose processor, a central processing unit (CPU), a microprocessor, a digital signal processor (DSP), a controller, a microcontroller, an arithmetic logic unit (ALU), a graphics processing unit (GPU), a microcomputer, a state machine, etc. In certain environments, processing circuitry may refer to an application-specific integrated circuit (ASIC), a programmable logic device (PLD), a field-programmable gate array (FPGA), a system-on-chip (SoC), etc. Processing circuitry may also refer to a combination of processing devices, such as a combination of a DSP and a microprocessor, a combination of multiple microprocessors, a combination of one or more microprocessors coupled with a DSP core, or any other such configuration. According to some example embodiments, a “module” or “unit” may be implemented by a processor and a memory. A “memory” should be broadly interpreted to include any non-transitory electronic component capable of storing electronic information. The “memory” may refer to various types of processor-readable media, such as random-access memory (RAM), read-only memory (ROM), non-volatile random-access memory (NVRAM), programmable read-only memory (PROM), erasable programmable read-only memory (EPROM), electrically erasable PROM (EEPROM), flash memory, magnetic or marking data storage devices, registers, etc. When a processor may read information from or write information to a memory, the memory is said to be in electronic communication with the processor. A memory integrated into the processor is in electronic communication with the processor.

In the following examples, terms such as first, second, A, B, (a), or (b) are used merely to distinguish one component from another; the terms do not limit the nature, sequence, or order of the components.

In the following examples, when a component is described as being “connected,” “coupled,” or “joined” to another component, the component may be directly connected or coupled to the other component or may be connected, coupled, or joined with another component interposed therebetween.

The terms “comprises” and/or “comprising,” as used in the following examples, do not exclude the presence or addition of one or more other components, operations, and/or elements.

Various examples of the present disclosure will now be described in detail with reference to the accompanying drawings.

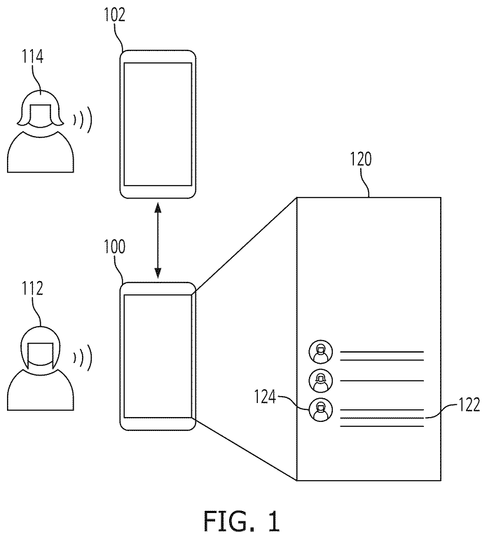

FIG. 1 is a diagram illustrating, by way of example, an electronic device 100 for processing call voice according to some example embodiments of the present disclosure. According to some example embodiments, the term “call voice” as used herein (may also be referred to as “call voice data”) may refer to an audio signal representing an utterance of a speaker (e.g., a user or counterpart) participating in a voice call. Referring to FIG. 1, the electronic device 100 may perform a call function. For example, the electronic device 100 may transmit data obtained by processing the voice of a user 112, received by a microphone, to an electronic device 102 of a counterpart 114 (e.g., another user), and may receive data obtained by processing the voice of the counterpart 114 from the electronic device 102 of the counterpart 114 through a communication module and output the data through a speaker. Here, a call may include a voice call in which voice is transmitted and received in real time and a video call in which video is transmitted and received together with voice, and may include various protocol-based calls such as VOIP. According to some example embodiments, operations described herein as being performed by the electronic device 100 and/or the electronic device 102 may be performed by processing circuitry.

According to some example embodiments, the electronic device 100 may convert real-time call voice (e.g., audio data corresponding to a voice in a voice call) into text during a call and display converted text 122 together with information 124 about a speaker on a screen 120. Thus, the electronic device 100 may provide real-time call content as not only voice information but also visual information. In addition, by displaying the text 122 obtained by converting call voice together with information 124 about the speaker, the electronic device 100 may support a user in clearly understanding the flow of conversation in accordance with the call content. The text 122 obtained by converting call voice and information 124 about the speaker may be displayed on the screen 120 in a conversation format among call participants. For example, the electronic device 100 may display call content in a conversation format supported by a chat application.

According to some example embodiments, in response to receiving a user input, the electronic device 100 may display, on the screen 120, text obtained by converting call voice associated with a time point earlier than a specified time and information about a speaker of the call voice. According to some example embodiments, the term “specified” as used herein may also be interpreted as given, defined, set, configured and/or selected (e.g., by a user of the electronic device 100). For example, the electronic device 100 may support a user in checking past call content. The user input may include at least one of an input selecting an object (e.g., a button object) displayed on the screen 120 and/or an input scrolling (or swiping) on the screen 120 in a specified direction. Accordingly, the electronic device 100 may support a user in easily checking past call content that is pushed off (e.g., disappears after being displayed) because of the size limitations of a specified display area of the screen 120. In an example, when an object displayed on the screen 120 is a button object that may return to a time point earlier than a specified time, the user may check call content at a time point earlier than the specified time by selecting the object. In another example, when the user input is a scroll input, the electronic device 100 may change the time point of call content to be displayed according to a scroll direction. For example, when an input scrolling in a first direction (e.g., upward) on the screen 120 is received, the electronic device 100 may display, on the screen 120, text obtained by converting call voice associated with a time point earlier than a currently displayed time point and information about a speaker of the call voice; when an input scrolling in a second direction (e.g., downward) on the screen 120 is received, the electronic device 100 may display, on the screen 120, text obtained by converting call voice associated with a time point later than the currently displayed time point and information about a speaker of the call voice. According to some example embodiments, the text and associated speaker information is displayed in chronological order with respect to a time at which voice data corresponding to the text is received. According to some example embodiments, the scrolling in the first direction refers to a direction opposite to the chronological order, and the scrolling in the second direction refers to a direction consistent with the chronological order.

According to some example embodiments, upon a screen switch, the electronic device 100 may display, on the switched screen, text obtained by converting call voice and information about a speaker. For example, the electronic device 100 may support a user in easily confirming call content even in a multitasking environment. The switched screen may be an execution screen of an application different from the call application or another execution screen of the call application. In an example, when the switched screen is an execution screen of an application different from the call application, the electronic device 100 may display, on the switched screen, text obtained by converting call voice and information about a speaker in a picture-in-picture (PIP) form (e.g., as an overlay superimposed on the execution screen of the application different from the call application). In another example, when the switched screen is an execution screen of a chat application linked with the call application, the electronic device 100 may display, on the switched screen, text obtained by converting call voice and information about a speaker in a conversation format supported by the chat application. In yet another example, when the switched screen is another execution screen of the call application (when the execution screen of the call application is switched from a first execution screen to a second execution screen), the electronic device 100 may display, on the switched screen, text obtained by converting call voice and information about a speaker in a conversation format among call participants.

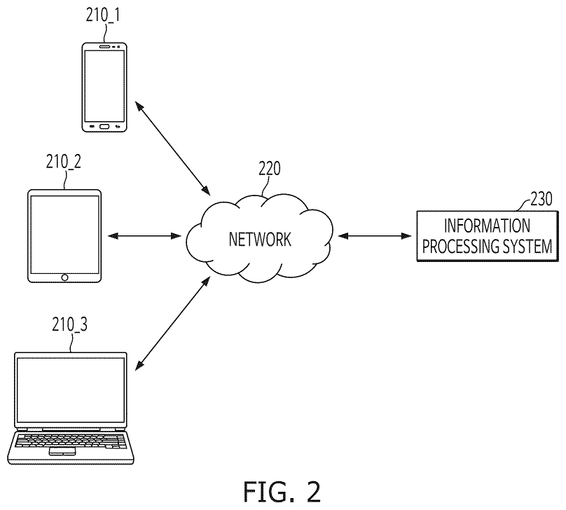

FIG. 2 is a diagram illustrating an overview configuration in which an information processing system 230 is connected so as to be able to communicate with multiple user terminals 210_1, 210_2, 210_3 in relation to data processing according to some example embodiments of the present disclosure. The information processing system 230 may include a system or systems capable of providing a data processing service (e.g., a call voice processing-based service). In some example embodiments, the information processing system 230 may include one or more server devices and/or databases capable of storing, providing, and executing computer-executable programs (e.g., downloadable applications) and data related to the data processing service, or one or more distributed computing devices and/or distributed databases based on a cloud computing service. For example, the information processing system 230 may include separate systems (e.g., servers) for the data processing service. According to some example embodiments, operations described herein as being performed by each of the multiple user terminals 210_1, 210_2, 210_3 and/or the information processing system 230 may be performed by processing circuitry. According to some example embodiments, each of the multiple user terminals 210_1, 210_2, 210_3 may correspond to the electronic device 100 and/or the electronic device 102.

A data processing service provided by the information processing system 230 may be provided to a user through a data processing application, a web browser application, or the like installed on each of the multiple user terminals 210_1, 210_2, 210_3.

The multiple user terminals 210_1, 210_2, 210_3 may communicate with the information processing system 230 through a network 220. The network 220 may be configured to enable communication between the multiple user terminals 210_1, 210_2, 210_3 and the information processing system 230. Depending on an installation environment, the network 220 may include, for example, wired networks such as Ethernet, a wired home network (power-line communication), telephone-line communication devices, or RS-serial communication, wireless networks such as a mobile communication network, a WLAN (wireless local area network), Wi-Fi, Bluetooth, or ZigBee, or a combination thereof. Communication methods are not limited, and the network 220 may include, in addition to communication methods using communication networks (e.g., a mobile communication network, wired Internet, wireless Internet, broadcasting network, or satellite network) included in the network 220, short-range wireless communication among user terminals 210_1, 210_2, 210_3.

For example, the multiple user terminals 210_1, 210_2, 210_3 may transmit, through the network 220, data processing requests and commands associated with user requests for data processing to the information processing system 230, and the information processing system 230 may receive them.

Although a phone terminal 210_1, a tablet terminal 210_2, and a PC terminal 210_3 are illustrated as examples of user terminals in FIG. 2, the present disclosure is not limited thereto, and the user terminals 210_1, 210_2, 210_3 may be any computing devices capable of wired and/or wireless communication and capable of executing a data processing application. For example, a user terminal may include a smartphone, a mobile phone, a navigation device, a computer, a notebook, a digital broadcasting terminal, a personal digital assistant (PDA), a portable multimedia player (PMP), a tablet PC, a game console, a wearable device, an Internet-of-Things (IoT) device, a virtual-reality (VR) device, an augmented-reality (AR) device, etc. Although three user terminals 210_1, 210_2, 210_3 are illustrated as communicating with the information processing system 230 through the network 220 in FIG. 2, the present disclosure is not limited thereto, and a different number of user terminals may be configured to communicate with the information processing system 230 through the network 220.

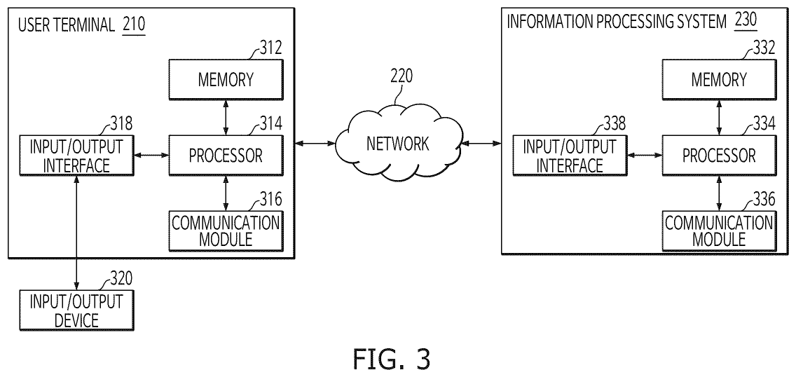

FIG. 3 is a block diagram illustrating internal configurations of a user terminal 210 and the information processing system 230 according to some example embodiments of the present disclosure. The user terminal 210 may refer to any computing device capable of executing a data processing application and capable of wired/wireless communication—for example, the phone terminal 210_1, the tablet terminal 210_2, or the PC terminal 210_3 of FIG. 2. As illustrated, the user terminal 210 may include a memory 312, a processor 314, a communication module 316, and/or an input/output interface 318. Likewise, the information processing system 230 may include a memory 332, a processor 334, a communication module 336, and/or an input/output interface 338. As illustrated in FIG. 3, the user terminal 210 and the information processing system 230 may be configured to communicate information and/or data through the network 220 by using their respective communication modules 316, 336. An input/output device 320 may be configured, through the input/output interface 318, to input information and/or data to the user terminal 210 or to output information and/or data generated by the user terminal 210. According to some example embodiments, the user terminal 210 may be an implementation of the electronic device 100 and/or the electronic device 102. According to some example embodiments, operations described herein as being performed by the user terminal 210, the processor 314, the communication module 316, the input/output interface 318, the information processing system 230, the processor 334, the communication module 336 and/or the input/output interface 338 may be performed by processing circuitry.

The memories 312, 332 may include any non-transitory computer-readable recording media. According to some example embodiments, the memories 312, 332 may include ROM, a disk drive, a solid-state drive (SSD), flash memory, or another permanent (or non-transitory, non-volatile) mass-storage device. In another example, the ROM, SSD, flash memory, or disk drive may be provided as a separate permanent storage device distinct from the memory and included in the user terminal 210 or the information processing system 230. The memories 312, 332 may store an operating system and at least one program code (e.g., code for an application related to the data processing service).

Such software components may be loaded from a non-transitory computer-readable recording medium separate from the memories 312, 332. The separate computer-readable recording medium may include a recording medium directly connectable to the user terminal 210 or the information processing system 230—for example, a floppy drive, a disk, a tape, a digital video disc (DVD)/compact disc (CD)-ROM drive, a memory card, etc. In another example, the software components may be loaded into the memories 312, 332 through the communication modules 316, 336 rather than through a computer-readable recording medium. For example, at least one program may be loaded into the memories 312, 332 based on a computer program (e.g., an application related to the data processing service) installed by files provided via the network 220 by a file distribution system that distributes installation files of developers or applications.

The processors 314, 334 may be configured to process computer program instructions (e.g., computer-readable instructions) by performing basic arithmetic, logic, and input/output operations. Instructions may be provided to the processors 314, 334 by the memories 312, 332 or the communication modules 316, 336. For example, each processor may be configured to execute instructions received according to program code stored in the corresponding memory.

The communication modules 316, 336 may provide configurations or functions for communication between the user terminal 210 and the information processing system 230 through the network 220, and may provide configurations or functions for communication between the user terminal 210 or the information processing system 230 and another user terminal or another system (e.g., a separate cloud system). For example, a request or data (e.g., a data processing request or data) generated by the processor 314 of the user terminal 210 according to program code stored in a recording device such as the memory 312 may be delivered to the information processing system 230 through the network 220 under the control of the communication module 316. Conversely, a control signal or command provided under the control of the processor 334 of the information processing system 230 may be received by the user terminal 210 through the communication module 316 and the network 220.

The input/output interface 318 may serve as means for interfacing with the input/output device 320. For example, the input/output device 320 may include an input device and/or an output device. The input device may include devices such as a camera including an audio sensor and/or an image sensor, a keyboard, a microphone, or a mouse, and the output device may include devices such as a display, a speaker, or a haptic-feedback device. In another example, the input/output interface 318 may serve as means for interfacing with a device in which configurations or functions for input and output are integrated together, such as a touchscreen. In FIG. 3, the input/output device 320 is illustrated as not being included in the user terminal 210, but the present disclosure is not limited thereto, and the input/output device 320 and the user terminal 210 may together constitute a single device. In addition, the input/output interface 338 of the information processing system 230 may serve as means for interfacing with an input or output device (not illustrated) connected to or included in the information processing system 230. In FIG. 3, the input/output interfaces 318, 338 are illustrated as elements separate from the processors 314, 334, but the present disclosure is not limited thereto, and the input/output interfaces 318, 338 may be configured to be included in the processors 314, 334.

The user terminal 210 and the information processing system 230 may include more components than those illustrated in FIG. 3. However, most conventional technical components need not be illustrated explicitly. In some example embodiments, the user terminal 210 may be implemented to include at least some of the above-described input/output devices 320. In addition, the user terminal 210 may further include other components such as a transceiver, a Global Positioning System (GPS) module, a camera, various sensors, or a database. For example, when the user terminal 210 is a smartphone, the user terminal 210 may include components generally included in a smartphone—for example, an accelerometer, a gyro sensor, a microphone module, a camera module, various physical buttons, buttons using a touch panel, input/output ports, or a vibrator for vibration—and various components may be further implemented in the user terminal 210.

According to some example embodiments, the processor 314 of the user terminal 210 may be configured to operate a data processing application or a web browser application that provides a data processing service. Program code associated with that application may be loaded into the memory 312 of the user terminal 210. While the application is operating, the processor 314 of the user terminal 210 may receive information and/or data provided from the input/output device 320 through the input/output interface 318 or receive information and/or data from the information processing system 230 through the communication module 316, and may process the received information and/or data and store them in the memory 312. Such information and/or data may also be provided to the information processing system 230 through the communication module 316.

While the data processing application is operating, the processor 314 may receive voice data, text, images, or video input or selected through input devices connected with the input/output interface 318, such as a touchscreen, a keyboard, a camera including an audio sensor and/or an image sensor, and/or a microphone, and may store the received voice data, text, images, and/or video in the memory 312 or provide them to the information processing system 230 through the communication module 316 and the network 220. In some example embodiments, the processor 314 may receive a user input through an input device and may provide data and/or requests corresponding to the received user input to the information processing system 230 through the network 220 and the communication module 316.

The processor 314 of the user terminal 210 may output information and/or data by transmitting them to the input/output device 320 through the input/output interface 318. For example, the processor 314 of the user terminal 210 may output processed information and/or data through an output device such as a display-outputable device (e.g., a touchscreen or display) or a voice-outputable device (e.g., a speaker).

The processor 334 of the information processing system 230 may be configured to manage, process, and/or store information and/or data received from multiple user terminals 210 and/or multiple external systems. Information and/or data processed by the processor 334 may be provided to the user terminal 210 through the communication module 336 and the network 220.

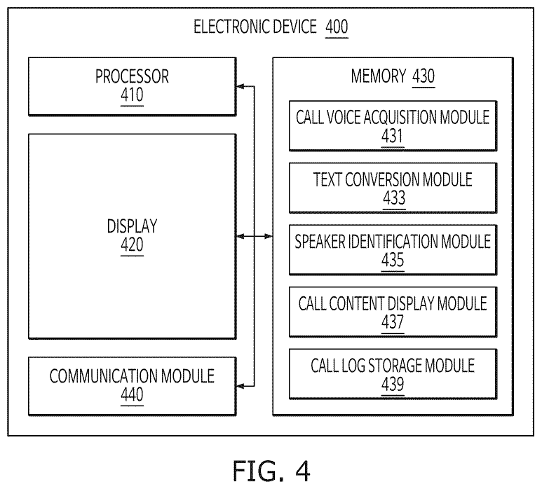

FIG. 4 is a diagram illustrating a configuration of an electronic device 400 for processing call voice according to some example embodiments of the present disclosure. Referring to FIG. 4, the electronic device 400 (e.g., the electronic device 100 of FIG. 1 and/or the user terminal 210 of FIG. 3) for processing call voice may include a processor 410, a display 420, a memory 430, and/or a communication module 440. However, the configuration of the electronic device 400 is not limited thereto. According to various examples, the electronic device 400 may omit at least one of the above-described components and/or may further include at least one other component. According to some example embodiments, operations described herein as being performed by the electronic device 400, the processor 410 and/or the communication module 440 may be performed by processing circuitry

The processor 410 may execute software (or a program) to control at least one other component (e.g., a hardware or software component) of the electronic device 400 connected to the processor 410 and may perform various data processing or operations. According to some example embodiments, as at least a part of data processing or operations, the processor 410 may load commands or data received from another component (e.g., the communication module 440) into volatile memory, process commands or data stored in the volatile memory, and store resultant data in non-volatile memory.

The display 420 may visually provide information. According to some example embodiments, the display 420 may display text obtained by converting call voice and information about a speaker. The display 420 may include, for example, a touch sensor configured to detect touch or a pressure sensor configured to measure a force generated by touch, and may include a sensor circuit or a control circuit for controlling the sensor.

The memory 430 may store various data used by at least one component (e.g., the processor 410) of the electronic device 400. The data may include, for example, software (or a program) and input or output data related to commands associated therewith. The memory 430 may include volatile memory or non-volatile memory. According to some example embodiments, the memory 430 may store a call log.

The memory 430 may include at least one instruction related to processing call voice. The at least one instruction may include, for example, instructions related to acquisition of call voice, conversion of call voice to text, identification of a speaker of call voice, display of call content, and/or storage of a call log. The memory 430 may include a call voice acquisition module 431, a text conversion module 433, a speaker identification module 435, a call content display module 437, and/or a call log storage module 439. However, the types of modules included in the memory 430 correspond to functions of the instructions, and their types and number are not limited thereto. In addition, the modules (or instructions included in a module) included in the memory 430 are executed by the processor 410 and may be implemented in the processor 410 itself. According to some example embodiments, operations described herein as being performed by the call voice acquisition module 431, the text conversion module 433, the speaker identification module 435, the call content display module 437, and/or the call log storage module 439 may be performed by processing circuitry.

The call voice acquisition module 431 may acquire call voice. For example, the call voice acquisition module 431 may acquire user voice data through a microphone. The call voice acquisition module 431 may also acquire voice data of a call counterpart from an external electronic device through the communication module 440. According to some example embodiments, the terms “call voice,” “call voice data” and/or “voice data” as used herein may refer to an audio signal representing an utterance of speaker (e.g., a user or counterpart) participating in a voice call.

The text conversion module 433 may convert voice data acquired through the call voice acquisition module 431 into text. For example, the text conversion module 433 may perform a speech-to-text (STT) function. The text conversion module 433 may remove noise from acquired voice data using a filter and may divide continuous voice data into multiple frames. Then, the text conversion module 433 may extract features from each of the divided frames and convert the voice data into text through a voice-recognition model based on the extracted features. Here, the voice-recognition model may include, for example, an acoustic model that analyzes voice data and classifies it into phonemes or syllables, and a language model that converts phonemes or syllables extracted from voice data into words or sentences.

The speaker identification module 435 may identify a speaker of acquired voice data. According to some example embodiments, the speaker identification module 435 may identify a speaker of voice data based on a source from which the voice data was acquired. In an example, when voice data was acquired through a microphone of the electronic device 400, the speaker identification module 435 may identify the speaker of the acquired voice data as a user of the electronic device 400. In another example, when voice data was acquired from an external electronic device through the communication module 440 of the electronic device 400, the speaker identification module 435 may identify the speaker of the acquired voice data as a user of the external electronic device—that is, a call counterpart. According to some example embodiments, the speaker identification module 435 may identify a speaker through voiceprint recognition for the voice data. For example, the speaker identification module 435 may analyze voice data, extract unique features of the voice data (e.g., a frequency spectrum), and identify a speaker of the voice data using the extracted unique features. According to some example embodiments, the speaker identification module 435 may identify a speaker of call voice based on at least one of a voice-recognition result of the call voice or information related to a speaker included in text obtained by converting the call voice. Here, information related to a speaker (may also be referred to herein as “speaker information”) may include information that may be used to identify the speaker (e.g., the speaker's name, nickname, or appellation).

The call content display module 437 may display call content on the display 420 during a call. For example, the call content display module 437 may display text obtained by converting call voice on a screen of the display 420 during a call.

According to some example embodiments, the call content display module 437 may display text obtained by converting real-time call voice together with information about a speaker on a screen. In this case, the call content display module 437 may display at least one of a current time and/or a call time (e.g., elapsed call time) together with the text obtained by converting call voice and information about a speaker on the screen.

According to some example embodiments, in response to receiving a first user input, the call content display module 437 may display, on a screen, first text obtained by converting call voice associated with a first time point earlier than a current time by a specified (or alternatively, given, defined, set or selected) duration (e.g., 10 seconds), together with information about a speaker of the call voice associated with the first time point. In this case, the call content display module 437 may display information regarding the first time point together with the first text and the information about the speaker of the call voice associated with the first time point on the screen. Here, the information regarding the first time point may include at least one of time information at the first time point and elapsed time information from a call start time point to the first time point. The first user input may include at least one of an input selecting an object (e.g., a button object) displayed on the screen, and/or an input scrolling (e.g., upward scrolling) or swiping (e.g., downward swiping) on the screen in a first direction.

According to some example embodiments, in response to receiving a second user input, the call content display module 437 may display, on the screen, second text obtained by converting call voice associated with a second time point later than the first time point, together with information about a speaker of the call voice associated with the second time point. For example, when the second user input is received while call content at a time point (the first time point) earlier than a currently displayed time point is displayed, the call content display module 437 may display call content at the second time point, which is after the displayed time point (the first time point) by a specified duration. Here, the second user input may include at least one of an input selecting an object (e.g., a button object) displayed on the screen, and/or an input scrolling (e.g., downward scrolling) or swiping (e.g., upward swiping) on the screen in a second direction opposite to the first direction. Accordingly, the call content display module 437 may change the time point of call content to be displayed based on the scroll direction (or swipe direction). According to some example embodiments, the text and associated speaker information is displayed in chronological order with respect to a time at which voice data corresponding to the text is received. According to some example embodiments, the scrolling in the first direction refers to a direction opposite to the chronological order, and the scrolling in the second direction refers to a direction consistent with the chronological order. According to some example embodiments, the swiping in the first direction refers to a direction consistent with the chronological order, and the swiping in the second direction refers to a direction opposite to the chronological order.

According to some example embodiments, after displaying the first text on the screen, when a specified duration has elapsed (e.g., passage of the specified duration) or when a third user input is received (may be referred to herein as satisfaction of at least one condition), the call content display module 437 may display, on the screen, text obtained by converting real-time call voice based on a current time and information about a speaker of the real-time call voice. For example, when the third user input is received or when the specified duration has elapsed while past call content is displayed, the call content display module 437 may restore the screen state to display real-time call content. Here, the third user input may include at least one of an input selecting an object (e.g., a button object) displayed on the screen and/or an input scrolling on the screen to an endpoint in the second direction (e.g., downward).

According to some example embodiments, when real-time call voice is received while the call content display module 437 displays the first text and information about a speaker of call voice associated with the first time point in a first area of the screen, the call content display module 437 may display, in a second area of the screen different from the first area, text obtained by converting the real-time call voice and information about a speaker of the real-time call voice. For example, when real-time call voice is received while past call content is displayed, the call content display module 437 may display real-time call content in a specified area (the second area) while maintaining the display state of past call content. Here, the second area may be an area fixed to a lower side of the first area.

According to some example embodiments, upon a screen switch, the call content display module 437 may display, on the switched screen, text obtained by converting real-time call voice together with information about a speaker. In this case, the call content display module 437 may display at least one of a current time and a call time (e.g., elapsed call time) together with the text obtained by converting call voice and information about a speaker on the switched screen. Here, the switched screen may include at least one of an execution screen of an application different from the call application, an execution screen of a chat application linked with the call application, or another execution screen of the call application. For convenience of description, the screen before switching is referred to as a first screen, and the screen after switching is referred to as a second screen.

According to some example embodiments, when the first screen is an execution screen of the call application and the second screen is an execution screen of an application different from the call application, the call content display module 437 may display, on the second screen, text obtained by converting call voice and information about a speaker in a PIP form. In this case, a PIP area set within the second screen may have a size that accommodates at least a specified number of pieces of text obtained by converting call voice.

According to some example embodiments, when the first screen is an execution screen of the call application and the second screen is an execution screen of a chat application linked with the call application, the call content display module 437 may, based on information about a speaker of call voice, display text obtained by converting call voice in a conversation format supported by the chat application on the second screen. In this case, to distinguish the chat application from a display of chat content—that is, to indicate that a call (not a chat) is ongoing—the call content display module 437 may display, on the second screen, an object (e.g., an image object) indicating a call state. In some example embodiments, while displaying text obtained by converting call voice in a conversation format on the second screen, the call content display module 437 may support execution of functions of the chat application. For example, while displaying text obtained by converting call voice in a conversation format on the second screen, the call content display module 437 may display, in time order, text (e.g., chat input text) input through the chat application on the second screen. That is, the electronic device 400 may support a user in performing a call and chatting with a call counterpart simultaneously (or contemporaneously). Although the example describes a case where the second screen is an execution screen of a chat application linked with the call application, the present disclosure is not limited thereto, and the second screen may include an execution screen of an SNS application or a message application that is linked with the call application and supports a conversation format.

According to some example embodiments, when the first screen is a first execution screen of the call application and the second screen is a second execution screen of the call application, the call content display module 437 may, based on information about a speaker of call voice, display text obtained by converting call voice in a conversation format among call participants on the second screen. In this case, the call content display module 437 may display, on the second screen, an object (e.g., an image object) indicating a call state, so as to indicate that a call is ongoing. Here, the first execution screen of the call application may be a first execution screen or a main screen of the call application, and the second execution screen of the call application may be a screen to which the first execution screen is switched in response to receiving a user input, and an area in which text obtained by converting call voice is displayed may occupy most of the screen.

According to some example embodiments, when text obtained by converting call voice includes specified text, the call content display module 437 may perform at least one of activation of an actuator for vibration and/or application of a visual effect to the second screen. For example, when specified text is detected in call content, the call content display module 437 may vibrate the electronic device 400 or apply a visual effect to the second screen. According to some example embodiments, the specified text may include information related to a user. Information related to a user may include information that may identify the user (e.g., the user's name, nickname, or appellation).

According to some example embodiments, when call voice is identified as sound corresponding to a specified pattern, the call content display module 437 may display, on a screen, an image mapped to the specified pattern together with information about a speaker of the call voice. Here, sound corresponding to the specified pattern may include at least one of sound generated by an action of the speaker (e.g., laughter or coughing) and/or sound generated by an external object (e.g., a car sound or music). In addition, the image mapped to the specified pattern (e.g., a sticker image) may include at least one of an image similar in form to the speaker's action and/or an image similar in form to the external object.

According to some example embodiments, the call content display module 437 may display, on at least one of the first screen or the second screen, information regarding a time point of real-time call voice together with text obtained by converting real-time call voice and information about a speaker of the real-time call voice. Here, the information regarding the time point of real-time call voice may include at least one of time information at which real-time call voice is received (e.g., current time information) and/or elapsed time information from a call start time point to a time point at which real-time call voice is received (e.g., a current time point). According to some example embodiments, information regarding the time point of real-time call voice displayed on the first screen and information regarding the time point of real-time call voice displayed on the second screen may have different formats. In an example, when information regarding the time point of real-time call voice displayed on the first screen includes current time information, information regarding the time point of real-time call voice displayed on the second screen may include elapsed time information from the call start time point to a current time point. In another example, when information regarding the time point of real-time call voice displayed on the first screen includes elapsed time information from the call start time point to a current time point, information regarding the time point of real-time call voice displayed on the second screen may include current time information.

The call log storage module 439 may store a call log. According to some example embodiments, the call log storage module 439 may perform overall processing of call logs. For example, the call log storage module 439 may perform processing related to storing, displaying, sharing, and/or modifying call logs.

According to some example embodiments, based on text obtained by converting real-time call voice and information about a speaker of the real-time call voice, the call log storage module 439 may store log information (may also be referred to herein as “first log information”) of a call. For example, in response to immediately (or promptly) after termination of a call or to receiving a fourth user input, the call log storage module 439 may store, in the memory 430, text obtained by converting real-time call voice and information about a speaker of the real-time call voice. In this case, the call log storage module 439 may store information regarding a time point of real-time call voice together with text obtained by converting the real-time call voice and information about a speaker of the real-time call voice. Here, the information regarding the time point of real-time call voice may include at least one of time information at which real-time call voice is received (current time information at the time of the call) or elapsed time information from a call start time point to a time point at which real-time call voice is received (a current time point at the time of the call).

According to some example embodiments, the call log storage module 439 may display log information of a call on a screen. For example, the call log storage module 439 may display log information of a call on a third screen different from the first screen and the second screen. According to some example embodiments, in response to receiving a fourth user input selecting an object (e.g., a button object) displayed on a fourth screen that is displayed immediately (or promptly) after termination of a call, the call log storage module 439 may display log information of the call on the third screen.

According to some example embodiments, when a fifth user input selecting specific text displayed on the first screen is received, the call log storage module 439 may display specific text (e.g., a subset of the converted text) differently from other text (e.g., a remainder of the converted text) within log information of the call displayed on the third screen. For example, when specific text within text obtained by converting real-time call voice is selected, the call log storage module 439 may store the selected text differently from other text upon storing log information of the call, and may display the selected text differently from other text upon displaying log information of the call based thereon.

According to some example embodiments, the call log storage module 439 may determine whether to store log information of a call based on whether a user is subscribed to a specified service (e.g., a premium service) after checking whether the user is subscribed to the specified service (may also be referred to herein as a “first service”). For example, the call log storage module 439 may store log information of a call only when the user is subscribed to the specified service.

According to some example embodiments, in response to receiving a sixth user input, the call log storage module 439 may transmit log information of a call to an external electronic device. For example, in response to receiving a sixth user input selecting a button object supporting sharing of call logs, the call log storage module 439 may share log information of a call with an electronic device of a call counterpart or another user's electronic device.

According to some example embodiments, the call log storage module 439 may determine whether to transmit log information of a call based on whether a user of the external electronic device is subscribed to a specified service after checking whether the user of the external electronic device is subscribed to the specified service. In an example, when a user of the external electronic device is not subscribed to the specified service, the call log storage module 439 may restrict sharing of log information of the call. In another example, when a user of the external electronic device is not subscribed to the specified service, the call log storage module 439 may transmit to the external electronic device either a portion of log information of the call (e.g., limited information) or information converted from the log information of the call into another format (e.g., an image capturing log information) of the call (may also be referred to herein as “second log information”).

According to some example embodiments, in response to receiving a seventh user input, the call log storage module 439 may modify at least a portion of log information of a call displayed on the third screen. For example, a user may modify text included in log information of the call.

According to some example embodiments, when a call is a multiparty call, the call log storage module 439 may, through filtering, search for utterances of a specific user within log information of the multiparty call. In an example, in response to receiving an eighth user input, the call log storage module 439 may search for utterances of a specific user within log information of the multiparty call displayed on the third screen and display the utterances differently from utterances of other users. In another example, in response to receiving an eighth user input, the call log storage module 439 may search for utterances of a specific user within log information of the multiparty call and display only the searched utterances of the specific user on the third screen.

The communication module 440 (or a communication circuit) may support establishment of a direct (e.g., wired) communication channel or a wireless communication channel between the electronic device 400 and an external electronic device (e.g., the electronic device 102 of FIG. 1), and communication through the established communication channel. According to some example embodiments, the electronic device 400 may receive voice data of a call counterpart from the external electronic device through the communication module 440.

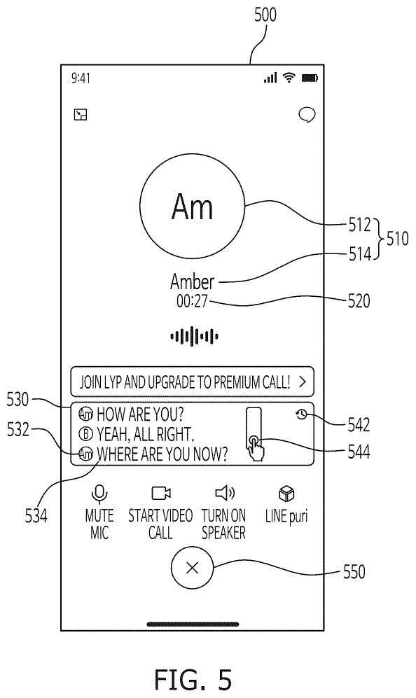

FIG. 5 is a diagram illustrating a method of displaying text 534 obtained by converting call voice and information 532 about a speaker on an execution screen 500 of a call application according to some example embodiments of the present disclosure. Referring to FIG. 5, a processor (e.g., the processor 410) of an electronic device (e.g., the electronic device 100 of FIG. 1 or the electronic device 400 of FIG. 4) for processing call voice may display, on the execution screen 500 of the call application, text 534 obtained by converting call voice and information 532 about a speaker of the call voice. For example, the processor may display call content on the screen during a call.

The execution screen 500 of the call application may include information 510 about a call counterpart, call time 520 (e.g., call duration), and/or an object 550 supporting termination of the call. The information 510 about a call counterpart may include at least one of an image 512 representing the call counterpart and/or a name 514 of the call counterpart. The call time 520 may include elapsed time information from a call start time point (e.g., an elapsed time representing a duration from a time point at the start of the call to a current time point). The object 550 supporting termination of the call may transmit a signal to the processor so that the call is terminated when selected by a user input.

According to some example embodiments, the execution screen 500 of the call application may include a first area 530 in which the text 534 obtained by converting call voice and information 532 about a speaker of the call voice are displayed. The first area 530 may be set at a specified position and with a specified size on the execution screen 500 of the call application.

According to some example embodiments, the first area 530 may display text obtained by converting real-time call voice, and text obtained by converting call voice associated with a time point (hereinafter referred to as a first time point) earlier than a specified time relative to a current time, together with information about a speaker of the call voice. A processor may receive a user input occurring in the first area 530 in order to display text obtained by converting call voice associated with the first time point. Here, the user input may include at least one of an input selecting an object 542 (e.g., a button object) displayed in the first area 530 or an input scrolling 544 (or swiping) in a specified direction on the first area 530. In an example, when the object 542 displayed in the first area 530 is selected, the processor may display, in the first area 530, text obtained by converting call voice associated with the first time point and information about a speaker of the call voice associated with the first time point. In another example, when an input scrolling 544 (or swiping) in a specified direction is received in the first area 530, the processor may display, in the first area 530, text obtained by converting call voice associated with the first time point and information about a speaker of the call voice associated with the first time point.

According to some example embodiments, call voice may be converted into text based on at least one of information related to a speaker of the call voice and/or information related to a recipient of the call voice. Here, information related to a speaker of call voice may be related to a language set for the speaker of the call voice and may include at least one of the nationality of the speaker of the call voice, a language used by the speaker of the call voice, and/or a language set in an electronic device (e.g., the electronic device 100 of FIG. 1) used by the speaker of the call voice. Information related to a recipient of call voice may be related to a language set for the recipient of the call voice and may include at least one of the nationality of the recipient of the call voice, a language used by the recipient of the call voice, and/or a language set in an electronic device (e.g., the electronic device 102 of FIG. 1) used by the recipient of the call voice. In an example, call voice may be converted into text (or text obtained by converting call voice may be translated) based on a language set for the speaker of the call voice. In another example, call voice may be converted into text (or text obtained by converting call voice may be translated) based on a language set for the recipient of the call voice. In yet another example, when the language set for the speaker of the call voice differs from the language set for the recipient of the call voice, call voice may be converted into text (or text obtained by converting call voice may be translated) based on a language (e.g., a first language) set for a user of the electronic device (e.g., a language set for the speaker of the call voice or a language set for the recipient of the call voice).

According to some example embodiments, an object associated with a translation function, capable of translating and displaying text obtained by converting call voice into a specified language (e.g., a language set for the speaker of the call voice, a language set for the recipient of the call voice, and/or a language set by a system or user), may be displayed in or adjacent to the first area 530. For example, when the language set for the speaker of the call voice differs from the language set for the recipient of the call voice, a processor may display the object associated with the translation function in or adjacent to the first area 530. When the object associated with the translation function is selected based on a user input, the processor may provide text obtained by converting call voice based on a specified language (e.g., a language set for the recipient of the call voice).

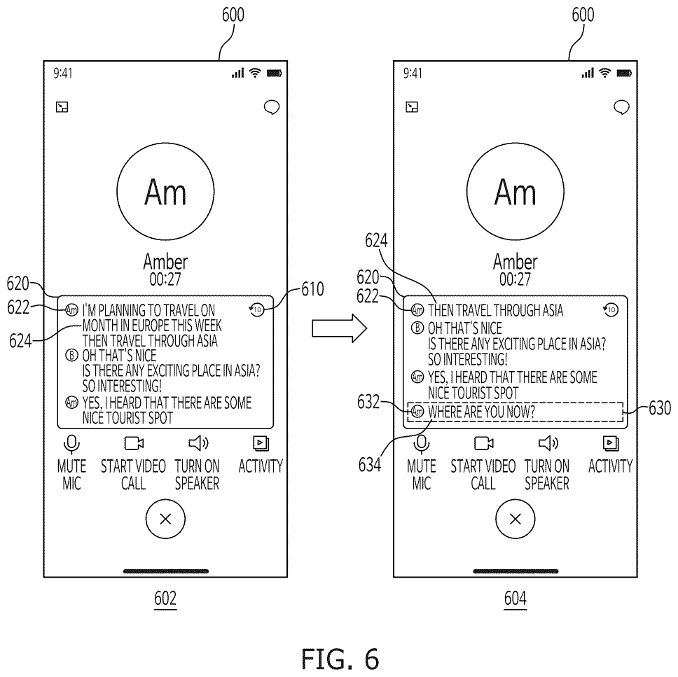

FIG. 6 is a diagram illustrating a method of processing real-time call voice while text 624 obtained by converting past call voice and information 622 about a speaker are displayed on an execution screen 600 of a call application according to some example embodiments of the present disclosure. Referring to FIG. 6, a processor (e.g., the processor 410) of an electronic device (e.g., the electronic device 100 of FIG. 1 or the electronic device 400 of FIG. 4) for processing call voice may display, in a first state 602, text 624 obtained by converting call voice associated with a time point (hereinafter referred to as a first time point) earlier than a specified time relative to a current time, together with information 622 about a speaker of the call voice associated with the first time point, on the execution screen 600 of the call application. For example, the processor may display past call content on the screen during a call. According to some example embodiments, in response to receiving a user input (hereinafter referred to as a first user input), the processor may display, in a first area 620 (e.g., the first area 530 of FIG. 5) of the screen, text 624 obtained by converting call voice associated with the first time point and information 622 about a speaker of the call voice associated with the first time point. For example, when an input selecting a first object 610 (e.g., the object 542 of FIG. 5) displayed in the first area 620 or an input scrolling (e.g., the scroll 544 of FIG. 5) in a first direction (e.g., upward) on the first area 620 is received, the execution screen 500 of the call application illustrated in FIG. 5 may be changed to the execution screen 600 of the call application illustrated in FIG. 6 in the first state 602. That is, text (e.g., the text 534 of FIG. 5) obtained by converting real-time call voice and information (e.g., the information 532 of FIG. 5) about a speaker of the real-time call voice displayed in the first area 620 may be scrolled in time order from the current time to the first time point, and finally the text 624 obtained by converting call voice associated with the first time point and information 622 about a speaker of the call voice associated with the first time point may be displayed in the first area 620.

According to some example embodiments, in response to receiving a user input (hereinafter referred to as a second user input), the processor may display, in the first area 620 of the screen, text obtained by converting call voice associated with a second time point later than the first time point and information about a speaker of the call voice associated with the second time point. For example, when the second user input is received while call content at a time point (the first time point) earlier than a currently displayed time point is displayed, the processor may display call content at the second time point, which is after the displayed time point (the first time point) by a specified duration. Here, the second user input may include at least one of an input selecting a second object (e.g., a button object) displayed in the first area 620 or an input scrolling on the first area 620 in a second direction (e.g., downward) opposite to the first direction. Accordingly, the processor may change the time point of call content to be displayed based on the scroll direction. The second object may support returning to a time point (the second time point) after the specified time. According to some example embodiments, the processor may change the first object 610 to the second object upon receiving the first user input. According to some example embodiments, the processor may display the first object 610 and the second object together in the first area 620.

According to some example embodiments, after displaying the text 624 obtained by converting call voice associated with the first time point in the first area 620, when a specified duration has elapsed or when a user input (hereinafter referred to as a third user input) is received, the processor may display, in the first area 620, text obtained by converting real-time call voice based on a current time and information about a speaker of the real-time call voice. For example, when the third user input is received or when the specified duration has elapsed while past call content is displayed, the processor may restore the screen state (e.g., the execution screen 500 of the call application illustrated in FIG. 5) to display real-time call content. Here, the third user input may include at least one of an input selecting a third object (e.g., a button object) displayed in the first area 620 or an input scrolling on the first area 620 to an endpoint in the second direction (e.g., downward).

According to some example embodiments, when real-time call voice is received while text 624 obtained by converting call voice associated with the first time point and information 622 about a speaker of the call voice associated with the first time point are displayed in the first area 620 of the screen (e.g., the first state 602), the processor may display, in a second area 630 of the screen different from the first area 620, text 634 obtained by converting real-time call voice and information 632 about a speaker of the real-time call voice, as illustrated in a second state 604. For example, when real-time call voice is received while past call content is displayed, the processor may display real-time call content in a specified area (e.g., the second area 630) while maintaining the display state of past call content. According to some example embodiments, the second area 630 may be an area fixed to a lower side of the first area 620.

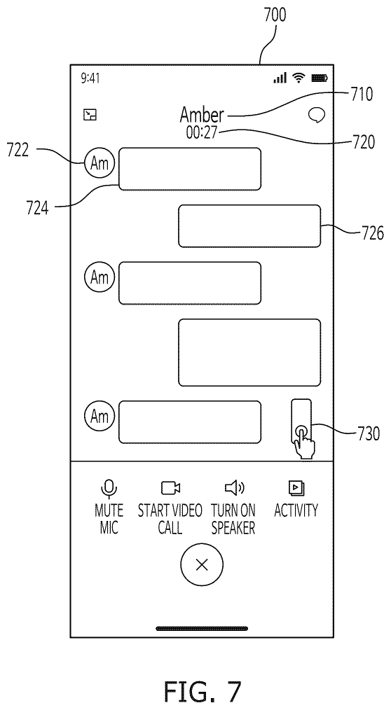

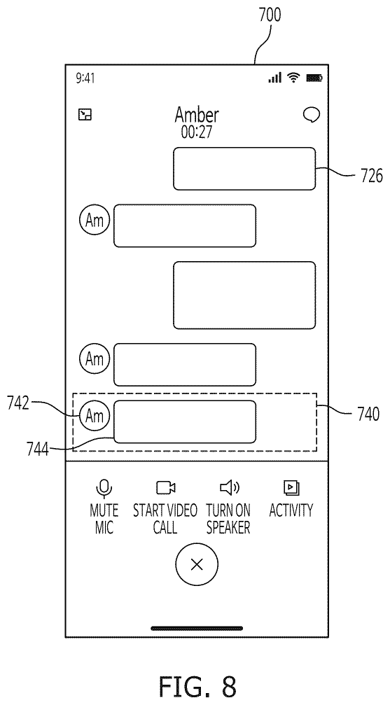

FIG. 7 is a diagram illustrating a method of displaying text 724, 726 obtained by converting call voice and information 722 about a speaker on another execution screen 700 of a call application according to some example embodiments of the present disclosure, and FIG. 8 is a diagram illustrating a method of processing real-time call voice while text 726 obtained by converting past call voice and information 722 about a speaker are displayed on another execution screen 700 of a call application according to some example embodiments of the present disclosure. Referring to FIGS. 7 and 8, a processor (e.g., the processor 410) of an electronic device (e.g., the electronic device 100 of FIG. 1 or the electronic device 400 of FIG. 4) for processing call voice may, upon a screen switch, display, on a switched screen, text 724, 726, 744 obtained by converting real-time call voice together with information 722, 742 about a speaker. In this case, the processor may display, on the switched screen, at least one of information 710 about a call counterpart, and/or a current time or a call time 720 (e.g., elapsed call time), together with the text 724, 726, 744 obtained by converting call voice and information 722, 742 about a speaker. Here, the switched screen may include another execution screen 700 of the call application. For convenience of description, the screen before switching is referred to as a first screen and the screen after switching is referred to as a second screen 700. For example, the first screen may be a first execution screen (e.g., the execution screen 500 of the call application illustrated in FIG. 5 or the execution screen 600 of the call application illustrated in FIG. 6) of the call application, which represents a first execution screen or a main screen of the call application, and the second screen 700 may be a second execution screen of the call application, which is a screen to which the first execution screen is switched in response to receiving a user input. According to some example embodiments, an area in which the text 724, 726, 744 obtained by converting call voice is displayed may occupy most of the second screen 700.

According to some example embodiments, based on information 722, 742 about a speaker of call voice, the processor may display the text 724, 726, 744 obtained by converting call voice in a conversation format (e.g., spatially associating each utterance with its corresponding speaker, and/or listing the utterances in chronological order) among call participants on the second screen 700. In this case, the processor may display, on the second screen 700, an object (e.g., an image object) indicating a call state so as to indicate that a call is ongoing. According to some example embodiments, when the speaker of call voice is a user of the electronic device, the processor may display only text 726 obtained by converting call voice uttered by the user, excluding information about the user, on the second screen 700.

According to some example embodiments, in response to receiving a user input (hereinafter referred to as a first user input), the processor may display, on the second screen 700, text obtained by converting call voice associated with a time point (hereinafter referred to as a first time point) earlier than a specified time relative to a current time and information about a speaker of the call voice associated with the first time point. For example, when an input selecting a first object (e.g., the object 542 of FIG. 5 or the object 610 of FIG. 6) displayed on the second screen 700 or an input scrolling 730 (e.g., the scroll 544 of FIG. 5) in a first direction (e.g., upward) on the second screen 700 is received, text 724, 726 obtained by converting real-time call voice and information 722 about a speaker of the real-time call voice displayed on the second screen 700 may be scrolled in time order from the current time to the first time point, and finally text obtained by converting call voice associated with the first time point and information about a speaker of the call voice associated with the first time point may be displayed on the second screen 700.

According to some example embodiments, in response to receiving a user input (hereinafter referred to as a second user input), the processor may display, on the second screen 700, text obtained by converting call voice associated with a second time point later than the first time point and information about a speaker of the call voice associated with the second time point. For example, when the second user input is received while call content at a time point (the first time point) earlier than a currently displayed time point is displayed, the processor may display call content at the second time point, which is after the displayed time point (the first time point) by a specified duration. Here, the second user input may include at least one of an input selecting a second object (e.g., a button object) displayed on the second screen 700 or an input scrolling on the second screen 700 in a second direction (e.g., downward) opposite to the first direction. Accordingly, the processor may change the time point of call content to be displayed based on the scroll direction.

According to some example embodiments, after displaying text obtained by converting call voice associated with the first time point on the second screen 700, when a specified duration has elapsed or when a user input (hereinafter referred to as a third user input) is received, the processor may display, on the second screen 700, text 724, 726 obtained by converting real-time call voice based on a current time and information 722 about a speaker of the real-time call voice. For example, when the third user input is received or when the specified duration has elapsed while past call content is displayed, the processor may restore the screen state to display real-time call content. Here, the third user input may include at least one of an input selecting a third object (e.g., a button object) displayed on the second screen 700 or an input scrolling on the second screen 700 to an endpoint in the second direction (e.g., downward).

According to some example embodiments, when real-time call voice is received while text obtained by converting call voice associated with the first time point and information about a speaker of the call voice associated with the first time point are displayed on the second screen 700, the processor may display, in a specified area 740 of the second screen 700, text 744 obtained by converting real-time call voice and information 742 about a speaker of the real-time call voice. For example, when real-time call voice is received while past call content is displayed, the processor may display real-time call content in the specified area 740 while maintaining the display state of past call content. According to some example embodiments, the specified area 740 may be an area fixed to a lower side of the second screen 700.

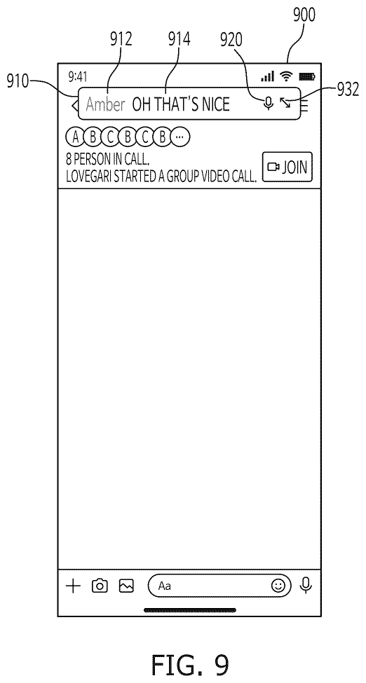

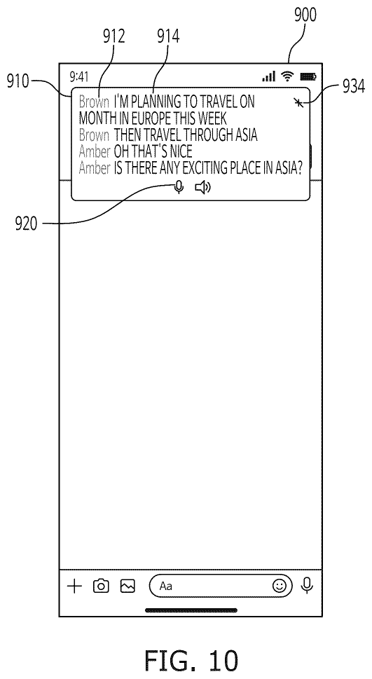

FIG. 9 is a diagram illustrating a method of displaying, in PIP form, text 914 obtained by converting call voice and information 912 about a speaker on an execution screen 900 of an application other than a call application after a screen switch according to some example embodiments of the present disclosure, and FIG. 10 is a diagram illustrating a method of changing a size of a PIP area 910 according to some example embodiments of the present disclosure. Referring to FIGS. 9 and 10, a processor (e.g., the processor 410) of an electronic device (e.g., the electronic device 100 of FIG. 1 or the electronic device 400 of FIG. 4) for processing call voice may, upon a screen switch, display, on a switched screen, text 914 obtained by converting real-time call voice together with information 912 about a speaker. In this case, the processor may display, on the switched screen, at least one of a current time or a call time (e.g., elapsed call time) together with the text 914 obtained by converting call voice and information 912 about a speaker. Here, the switched screen may include an execution screen 900 of an application (e.g., a game application) different from the call application. For convenience of description, the screen before switching is referred to as a first screen and the screen after switching is referred to as a second screen 900. For example, the first screen may be an execution screen (e.g., the execution screen 500 of the call application illustrated in FIG. 5 or the execution screen 600 of the call application illustrated in FIG. 6) of the call application, and the second screen 900 may be an execution screen of an application other than the call application.

According to some example embodiments, the processor may display, on the second screen 900, text 914 obtained by converting call voice and information 912 about a speaker in a PIP form. In this case, a PIP area 910 set within the second screen 900 may have a size that accommodates at least a specified number of pieces of text 914 (e.g., a specified number of characters, letters, words, sentences or utterances) obtained by converting call voice. In addition, to indicate that a call is ongoing, the processor may display, on the second screen 900, an object 920 (e.g., an image object) indicating a call state. For example, the object 920 indicating a call state may be displayed in the PIP area 910.

According to some example embodiments, the processor may display, in the PIP area 910, objects 932, 934 capable of changing a size of the PIP area 910. In an example, when a first object 932 displayed in the PIP area 910 is selected, the processor may enlarge the PIP area 910, as illustrated in FIG. 10. In another example, when a second object 934 displayed in the PIP area 910 is selected, the processor may reduce the PIP area 910, as illustrated in FIG. 9. According to some example embodiments, in response to receiving a user input selecting the first object 932, the processor may change the first object 932 to the second object 934, and in response to receiving a user input selecting the second object 934, the processor may change the second object 934 to the first object 932. For example, the processor may toggle the objects 932, 934 capable of changing the size of the PIP area 910.

According to some example embodiments, in response to receiving a user input (hereinafter referred to as a first user input), the processor may display, in the PIP area 910, text obtained by converting call voice associated with a time point (hereinafter referred to as a first time point) earlier than a specified time relative to a current time and information about a speaker of the call voice associated with the first time point. For example, when an input selecting a first object (e.g., the object 542 of FIG. 5 or the object 610 of FIG. 6) displayed in the PIP area 910 or an input scrolling (e.g., the scroll 544 of FIG. 5) in a first direction (e.g., upward) on the PIP area 910 is received, text 914 obtained by converting real-time call voice and information 912 about a speaker of the real-time call voice displayed in the PIP area 910 may be scrolled in time order from the current time to the first time point, and finally text obtained by converting call voice associated with the first time point and information about a speaker of the call voice associated with the first time point may be displayed in the PIP area 910.

According to some example embodiments, in response to receiving a user input (hereinafter referred to as a second user input), the processor may display, in the PIP area 910, text obtained by converting call voice associated with a second time point later than the first time point and information about a speaker of the call voice associated with the second time point. For example, when the second user input is received while call content at a time point (the first time point) earlier than a currently displayed time point is displayed, the processor may display call content at the second time point, which is after the displayed time point (the first time point) by a specified duration. Here, the second user input may include at least one of an input selecting a second object (e.g., a button object) displayed in the PIP area 910 or an input scrolling on the PIP area 910 in a second direction (e.g., downward) opposite to the first direction. Accordingly, the processor may change the time point of call content to be displayed based on the scroll direction.

According to some example embodiments, after displaying text obtained by converting call voice associated with the first time point in the PIP area 910, when a specified duration has elapsed or when a user input (hereinafter referred to as a third user input) is received, the processor may display, in the PIP area 910, text 914 obtained by converting real-time call voice based on a current time and information 912 about a speaker of the real-time call voice. For example, when the third user input is received or when the specified duration has elapsed while past call content is displayed, the processor may restore the screen state to display real-time call content. Here, the third user input may include at least one of an input selecting a third object (e.g., a button object) displayed in the PIP area 910 or an input scrolling on the PIP area 910 to an endpoint in the second direction (e.g., downward).

According to some example embodiments, when real-time call voice is received while text obtained by converting call voice associated with the first time point and information about a speaker of the call voice associated with the first time point are displayed in the PIP area 910, the processor may display, in a specified area of the PIP area 910, text 914 obtained by converting real-time call voice and information 912 about a speaker of the real-time call voice. For example, when real-time call voice is received while past call content is displayed, the processor may display real-time call content in the specified area while maintaining the display state of past call content. According to some example embodiments, the specified area may be an area fixed to a lower side of the PIP area 910.

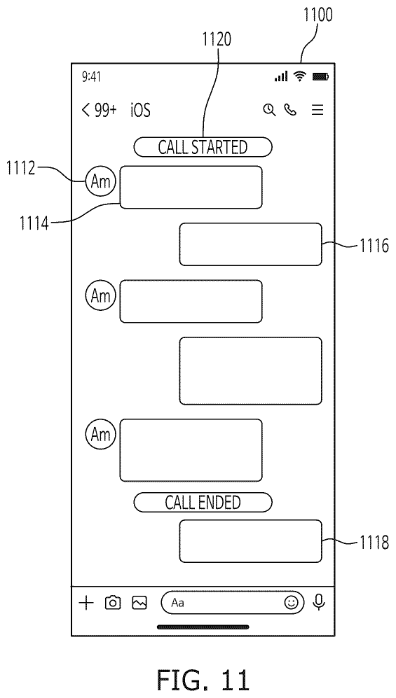

FIG. 11 is a diagram illustrating a method of displaying text 1114, 1116 obtained by converting call voice and information 1112 about a speaker on an execution screen 1100 of a chat application linked with a call application according to some example embodiments of the present disclosure. Referring to FIG. 11, a processor (e.g., the processor 410) of an electronic device (e.g., the electronic device 100 of FIG. 1 or the electronic device 400 of FIG. 4) for processing call voice may, upon a screen switch, display, on a switched screen, text 1114, 1116 obtained by converting real-time call voice together with information 1112 about a speaker. In this case, the processor may display, on the switched screen, at least one of a current time or a call time (e.g., elapsed call time) together with the text 1114, 1116 obtained by converting call voice and information 1112 about a speaker. Here, the switched screen may include an execution screen 1100 of a chat application linked with the call application. Although the switched screen is described as being an execution screen 1100 of a chat application linked with the call application in FIG. 11, the present disclosure is not limited thereto, and the switched screen may include an execution screen of an SNS application or a message application that is linked with the call application and supports a conversation format. For convenience of description, the screen before switching is referred to as a first screen and the screen after switching is referred to as a second screen 1100. For example, the first screen may be an execution screen (e.g., the execution screen 500 of the call application illustrated in FIG. 5 or the execution screen 600 of the call application illustrated in FIG. 6) of the call application, and the second screen 1100 may be an execution screen of a chat application linked with the call application.

According to some example embodiments, based on information 1112 about a speaker of call voice, the processor may display text 1114, 1116 obtained by converting call voice in a conversation format (e.g., spatially associating each utterance with its corresponding speaker, and/or listing the utterances in chronological order) supported by the chat application on the second screen 1100. In this case, to distinguish the chat application from a display of chat content—that is, to indicate that a call (not a chat) is ongoing—the processor may display, on the second screen 1100, an object 1120 (e.g., a text-box object) indicating a call state. According to some example embodiments, when the speaker of call voice is a user of the electronic device, the processor may display only text 1116 obtained by converting call voice uttered by the user, excluding information about the user, on the second screen 1100.

According to some example embodiments, while displaying text 1114, 1116 obtained by converting call voice in a conversation format on the second screen 1100, the processor may support execution of functions of the chat application. For example, while displaying text 1114, 1116 obtained by converting call voice in a conversation format on the second screen 1100, the processor may display, in time order, text 1118 (e.g., chat input text) input through the chat application on the second screen 1100. That is, the electronic device may support a user in performing a call and chatting with a call counterpart simultaneously (or contemporaneously).

According to some example embodiments, in response to receiving a user input (hereinafter referred to as a first user input), the processor may display, on the second screen 1100, text obtained by converting call voice associated with a time point (hereinafter referred to as a first time point) earlier than a specified time relative to a current time and information about a speaker of the call voice associated with the first time point. For example, when an input selecting a first object (e.g., the object 542 of FIG. 5 or the object 610 of FIG. 6) displayed on the second screen 1100 or an input scrolling (e.g., the scroll 544 of FIG. 5) in a first direction (e.g., upward) on the second screen 1100 is received, text 1114, 1116 obtained by converting real-time call voice and information 1112 about a speaker of the real-time call voice displayed on the second screen 1100 may be scrolled in time order from the current time to the first time point, and finally text obtained by converting call voice associated with the first time point and information about a speaker of the call voice associated with the first time point may be displayed on the second screen 1100.

According to some example embodiments, in response to receiving a user input (hereinafter referred to as a second user input), the processor may display, on the second screen 1100, text obtained by converting call voice associated with a second time point later than the first time point and information about a speaker of the call voice associated with the second time point. For example, when the second user input is received while call content at a time point (the first time point) earlier than a currently displayed time point is displayed, the processor may display call content at the second time point, which is after the displayed time point (the first time point) by a specified duration. Here, the second user input may include at least one of an input selecting a second object (e.g., a button object) displayed on the second screen 1100 or an input scrolling on the second screen 1100 in a second direction (e.g., downward) opposite to the first direction. Accordingly, the processor may change the time point of call content to be displayed based on the scroll direction.

According to some example embodiments, after displaying text obtained by converting call voice associated with the first time point on the second screen 1100, when a specified duration has elapsed or when a user input (hereinafter referred to as a third user input) is received, the processor may display, on the second screen 1100, text 1114, 1116 obtained by converting real-time call voice based on a current time and information 1112 about a speaker of the real-time call voice. For example, when the third user input is received or when the specified duration has elapsed while past call content is displayed, the processor may restore the screen state to display real-time call content. Here, the third user input may include at least one of an input selecting a third object (e.g., a button object) displayed on the second screen 1100 or an input scrolling on the second screen 1100 to an endpoint in the second direction (e.g., downward).

According to some example embodiments, when real-time call voice is received while text obtained by converting call voice associated with the first time point and information about a speaker of the call voice associated with the first time point are displayed on the second screen 1100, the processor may display, in a specified area of the second screen 1100, text obtained by converting real-time call voice and information about a speaker of the real-time call voice. For example, when real-time call voice is received while past call content is displayed, the processor may display real-time call content in the specified area while maintaining the display state of past call content. According to some example embodiments, the specified area may be an area fixed to a lower side of the second screen 1100.

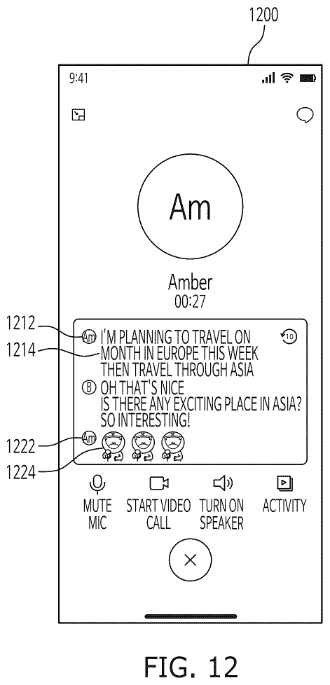

FIG. 12 is a diagram illustrating a method of processing sound corresponding to a specified pattern among call voice according to some example embodiments of the present disclosure. Referring to FIG. 12, a processor (e.g., the processor 410) of an electronic device (e.g., the electronic device 100 of FIG. 1 or the electronic device 400 of FIG. 4) for processing call voice may display, on an execution screen 1200 of a call application, text 1214 obtained by converting call voice and information 1212 about a speaker of the call voice. For example, the processor may display call content on the screen during a call.

According to some example embodiments, when call voice is identified as sound corresponding to a specified pattern, the processor may display, on the screen, an image 1224 mapped to the specified pattern together with information 1222 about a speaker of the call voice. Here, sound corresponding to the specified pattern may include at least one of sound generated by an action of the speaker (e.g., laughter or coughing) or sound generated by an external object (e.g., a car sound or music). In addition, the image 1224 mapped to the specified pattern may include, for example, a sticker image and may include at least one of an image similar in form to the speaker's action or an image similar in form to the external object.

According to some example embodiments, when text 1214 obtained by converting call voice includes specified text, the processor may perform at least one of activation of an actuator for vibration, application of a visual effect to an area in which the text 1214 obtained by converting call voice is displayed, and/or application of a visual effect to an area in which specified text is displayed within the text 1214 obtained by converting call voice. For example, when specified text is detected in call content, the processor may vibrate the electronic device or apply a visual effect to an area in which the text 1214 obtained by converting call voice is displayed or to an area in which specified text is displayed within the text 1214 obtained by converting call voice. According to some example embodiments, the specified text may include information related to a user. Information related to a user may include information that may be used to identify the user (e.g., the user's name, nickname, or appellation).

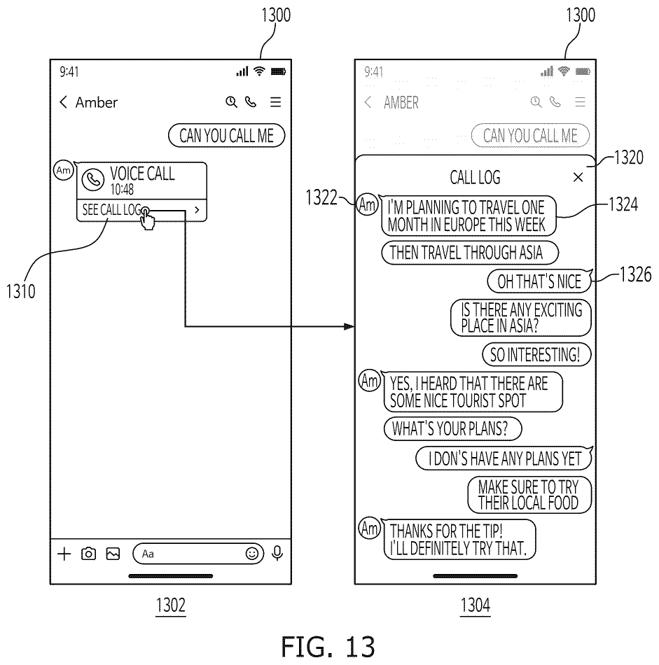

FIG. 13 is a diagram illustrating a method of processing a call log according to some example embodiments of the present disclosure. Referring to FIG. 13, a processor (e.g., the processor 410) of an electronic device (e.g., the electronic device 100 of FIG. 1 or the electronic device 400 of FIG. 4) for processing call voice may store log information of a call based on text 1324, 1326 obtained by converting real-time call voice and information 1322 about a speaker of the real-time call voice. For example, immediately (or promptly) after termination of a call or in response to receiving a user input, the processor may store, in a memory (e.g., the memory 430 of FIG. 4), text 1324, 1326 obtained by converting real-time call voice and information 1322 about a speaker of the real-time call voice. In this case, the processor may store information regarding a time point of real-time call voice together with text 1324, 1326 obtained by converting real-time call voice and information 1322 about a speaker of the real-time call voice. Here, information regarding the time point of real-time call voice may include at least one of time information at which real-time call voice is received (current time information at the time of the call) or elapsed time information from a call start time point to a time point at which real-time call voice is received (a current time point at the time of the call).

According to some example embodiments, the processor may display log information of a call on a screen 1320. For example, in response to receiving a user input selecting an object 1310 (e.g., a button object) included in a screen 1300 displayed immediately (or promptly) after termination of a call, as illustrated in a first state 1302, the processor may display log information of the call on the screen 1320, as illustrated in a second state 1304. FIG. 13 illustrates a state in which the screen 1320 displaying log information of a call is output superimposed on the screen 1300 displayed immediately (or promptly) after termination of the call. For example, the processor may display log information of a call in a popup form.

According to some example embodiments, when a user input selecting specific text displayed on a screen (e.g., the execution screen 500 of the call application illustrated in FIG. 5, the execution screen 600 of the call application illustrated in FIG. 6, the execution screen 700 of the call application illustrated in FIGS. 7 and 8, the execution screen 900 of the application different from the call application illustrated in FIGS. 9 and 10, the execution screen 1100 of the chat application linked with the call application illustrated in FIG. 11, or the execution screen 1200 of the call application illustrated in FIG. 12) is received, the processor may display, within log information of a call displayed on the screen 1320, specific text differently from other text. For example, when specific text within text obtained by converting real-time call voice is selected, the processor may store the selected text differently from other text upon storing log information of a call, and may display the selected text differently from other text upon displaying log information of a call based thereon.

According to some example embodiments, the processor may determine whether to store log information of a call based on whether a user is subscribed to a specified service (e.g., a premium service) after checking whether the user is subscribed to the specified service. For example, the processor may store log information of a call only when the user is subscribed to the specified service.

According to some example embodiments, in response to receiving a user input, the processor may transmit log information of a call to an external electronic device. For example, in response to receiving a user input selecting a button object supporting sharing of call logs, the processor may share log information of a call with an electronic device of a call counterpart or another user's electronic device.

According to some example embodiments, the processor may determine whether to transmit log information of a call based on whether a user of the external electronic device is subscribed to a specified service (e.g., a premium service) after checking whether the user of the external electronic device is subscribed to the specified service. In an example, when a user of the external electronic device is not subscribed to the specified service, the processor may restrict sharing of log information of the call. In another example, when a user of the external electronic device is not subscribed to the specified service, the processor may transmit to the external electronic device either a portion of log information of the call (e.g., limited information) or information converted from the log information of the call into another format (e.g., at least a part of log information of the call captured as an image).

According to some example embodiments, in response to receiving a user input, the processor may modify at least a portion of log information of a call. For example, a user may modify text included in log information of a call.

According to some example embodiments, when a call is a multiparty call, the processor may, through filtering, search for utterances of a specific user within log information of the multiparty call. In an example, in response to receiving a user input, the processor may search for utterances of a specific user within log information of the multiparty call and display the utterances differently from utterances of other users. In another example, in response to receiving a user input, the processor may search for utterances of a specific user within log information of the multiparty call and display only the searched utterances of the specific user on the screen 1320.

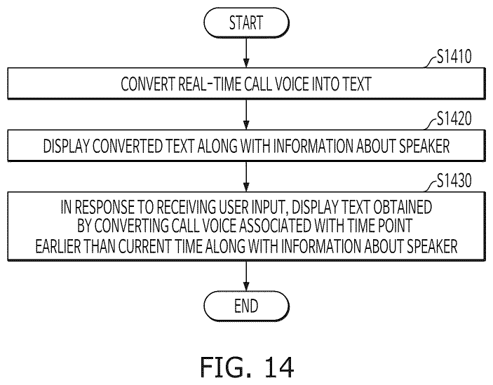

FIG. 14 is a diagram illustrating a method of displaying text obtained by converting past call voice and information about a speaker among a call voice processing method according to some example embodiments of the present disclosure. Referring to FIG. 14, a processor (e.g., the processor 410) of an electronic device (e.g., the electronic device 100 of FIG. 1 or the electronic device 400 of FIG. 4) for processing call voice may, in operation S1410, convert real-time call voice into text. For example, the processor may convert, into text through an STT function, at least one of user call voice obtained in real time through a microphone or call voice of a call counterpart obtained in real time from an external electronic device through a communication module (e.g., the communication module 440 of FIG. 4).

In operation S1420, the processor may display the converted text together with information about a speaker. For example, the processor may identify a speaker of acquired voice. In an example, when voice was acquired through a microphone of the electronic device, the processor may identify the speaker of the acquired voice as a user of the electronic device. In another example, when voice was acquired from an external electronic device through a communication module of the electronic device, the processor may identify the speaker of the acquired voice as a user of the external electronic device—that is, a call counterpart. In still another example, the processor may identify a speaker through voiceprint recognition for the voice. In yet another example, the processor may identify a speaker of call voice based on at least one of a voice-recognition result of the call voice or information related to a speaker included in text obtained by converting the call voice. Here, information related to a speaker may include information that may be used to identify the speaker (e.g., the speaker's name, nickname, or appellation). Then, the processor may display, on a screen, text obtained by converting real-time call voice together with information about a speaker. In this case, the processor may display at least one of a current time or a call time (e.g., elapsed call time) together with the text obtained by converting call voice and information about a speaker on the screen.

In operation S1430, in response to receiving a user input, the processor may display, together with information about a speaker, text obtained by converting call voice associated with a time point earlier than a current time. For example, in response to receiving a user input, the processor may display, on the screen, first text obtained by converting call voice associated with a first time point earlier than a current time by a specified duration (e.g., 10 seconds) together with information about a speaker of the call voice associated with the first time point. In this case, the processor may display information regarding the first time point together with the first text and information about a speaker of the call voice associated with the first time point on the screen. Here, the information regarding the first time point may include at least one of time information at the first time point and elapsed time information from a call start time point to the first time point. The user input may include at least one of an input selecting an object (e.g., a button object) displayed on the screen and an input scrolling (or swiping) on the screen in a specified direction.

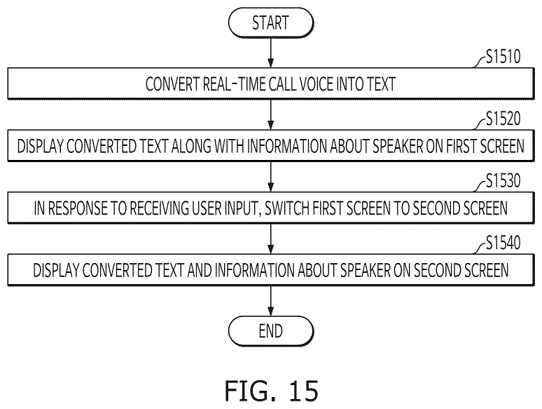

FIG. 15 is a diagram illustrating a method of displaying text obtained by converting call voice and information about a speaker on a switched screen when the screen is switched among a call voice processing method according to some example embodiments of the present disclosure. Referring to FIG. 15, a processor (e.g., the processor 410) of an electronic device (e.g., the electronic device 100 of FIG. 1 or the electronic device 400 of FIG. 4) for processing call voice may, in operation S1510, convert real-time call voice into text. For example, the processor may convert, into text through an STT function, at least one of user call voice obtained in real time through a microphone or call voice of a call counterpart obtained in real time from an external electronic device through a communication module (e.g., the communication module 440 of FIG. 4).

In operation S1520, the processor may display the converted text together with information about a speaker on a first screen. For example, the processor may identify a speaker of acquired voice. In an example, when voice was acquired through a microphone of the electronic device, the processor may identify the speaker of the acquired voice as a user of the electronic device. In another example, when voice was acquired from an external electronic device through a communication module of the electronic device, the processor may identify the speaker of the acquired voice as a user of the external electronic device—that is, a call counterpart. In still another example, the processor may identify a speaker through voiceprint recognition for the voice. In yet another example, the processor may identify a speaker of call voice based on at least one of a voice-recognition result of the call voice or information related to a speaker included in text obtained by converting the call voice. Here, information related to a speaker may include information that may be used to identify the speaker (e.g., the speaker's name, nickname, or appellation). Then, the processor may display, on the first screen, text obtained by converting real-time call voice together with information about a speaker. In this case, the processor may display at least one of a current time or a call time (e.g., elapsed call time) together with the text obtained by converting call voice and information about a speaker on the first screen.

In operation S1530, in response to receiving a user input, the processor may switch the first screen to a second screen. Here, when the first screen is an execution screen of a call application, the second screen may be an execution screen of an application other than the call application. Alternatively, when the first screen is an execution screen of a call application, the second screen may be an execution screen of an application (e.g., a chat application, an SNS application, or a message application) that is linked with the call application and supports a conversation format. Alternatively, when the first screen is a first execution screen of a call application, the second screen may be a second execution screen of the call application. Here, the first execution screen of the call application may be a first execution screen or a main screen of the call application, and the second execution screen of the call application, which is switched from the first execution screen of the call application in response to receiving a user input, may be a screen in which an area displaying text obtained by converting call voice occupies most of the screen.

In operation S1540, the processor may display the converted text and information about a speaker on the second screen. For example, the processor may display, on the second screen, text obtained by converting real-time call voice together with information about a speaker. In this case, the processor may display at least one of a current time or a call time (e.g., elapsed call time) together with the text obtained by converting call voice and information about a speaker on the second screen.

According to some example embodiments, when the first screen is an execution screen of a call application and the second screen is an execution screen of an application different from the call application, the processor may display, on the second screen, text obtained by converting call voice and information about a speaker in a PIP form. In this case, a PIP area set within the second screen may have a size that accommodates at least a specified number of pieces of text obtained by converting call voice.

According to some example embodiments, when the first screen is an execution screen of a call application and the second screen is an execution screen of a chat application linked with the call application, the processor may, based on information about a speaker of call voice, display text obtained by converting call voice in a conversation format supported by the chat application on the second screen. In this case, to distinguish the chat application from a display of chat content—that is, to indicate that a call (not a chat) is ongoing—the processor may display, on the second screen, an object (e.g., an image object) indicating a call state. In some example embodiments, while displaying text obtained by converting call voice in a conversation format on the second screen, the processor may support execution of functions of the chat application. For example, while displaying text obtained by converting call voice in a conversation format on the second screen, the processor may display, in time order, text (e.g., chat input text) input through the chat application on the second screen.

According to some example embodiments, when the first screen is a first execution screen of a call application and the second screen is a second execution screen of the call application, the processor may, based on information about a speaker of call voice, display text obtained by converting call voice in a conversation format among call participants on the second screen. In this case, to indicate that a call is ongoing, the processor may display, on the second screen, an object (e.g., an image object) indicating a call state.

Conventional devices and methods for performing a real-time voice call involve transferring real-time audio data through a call application executing on respective devices of participants of the voice call. A participant using the conventional devices and methods may miss a portion of the real-time voice call (e.g., an utterance made by a counterpart), for example, due to activation of another application different to the call application during the real-time voice call. The conventional devices and methods do not maintain (e.g., store) the real-time audio data for later reference, and thus, the participant is unable to recover the missed portion of the real-time voice call.

However, according to some example embodiments, improved devices and methods are provided for performing a real-time voice call. For example, the improved devices and methods include converting real-time audio data of the voice call into text, and displaying the text for reference during (and in some cases, after) the voice call. Accordingly, a participant (e.g., a user) that misses a portion of the real-time voice call may recover the missed portion by reading the displayed text.

Also, according to some example embodiments, the improved devices and methods may enable the text to be displayed while an application different from a call application is activated, thereby enabling the participant to follow the real-time voice call while using the different application. For example, even in a scenario in which the participant is unable to hear the real-time audio data of the voice call while the different application is activated, the participant would be able to read the text generated based on the conversion of the audio data.

Additionally, according to some example embodiments, the improved devices and methods may enable the participant to select different portions of the text to be displayed (e.g., portions of the text corresponding to different time points). For example, due to size limitations of displays, only a specified amount of text may be legibly provided on a display. This limitation is even more substantial in scenarios involving smaller displays, as with mobile devices (e.g., smartphones, personal digital assistants, laptop computers, etc.) However, by enabling the participant to select different portions of the text to be displayed, the participant may select text corresponding to a missed portion of the real-time voice call and/or a current portion of the real-time voice call notwithstanding the limited size of the display.

In view of the above, the improved devices and methods overcome the deficiencies of the conventional devices and methods to at least enable a participant in a real-time voice call to recover a missed portion of the voice call.

The flowchart and descriptions above are merely illustrative, and some example embodiments may be implemented differently. For example, in some example embodiments, the order of the operations may be changed, some operations may be performed repeatedly, some operations may be omitted, and/or additional operations may be added.

The foregoing methods may be provided as computer programs stored on non-transitory computer-readable recording media for execution by a computer. The media may store the computer-executable program permanently or temporarily for execution or download. The media may be various recording or storage means having single or multiple hardware combined, not limited to media directly connected to a computer system, and may exist distributed over a network. Examples of the media include magnetic media such as hard disks, floppy disks, and magnetic tape; optical recording media such as CD-ROM and DVD; magneto-optical media such as floptical disks; and ROM, RAM, and flash memory, all configured to store program instructions. Other examples include recording or storage media managed by application distribution app stores or other software distribution sites or servers.

The methods, operations, or techniques of the present disclosure may be implemented by various means. For example, such techniques may be implemented by hardware, firmware, software, or a combination thereof. Those skilled in the art will understand that various exemplary logical blocks, modules, circuits, and algorithm operations described in connection with the present disclosure may be implemented by electronic hardware, computer software, or combinations of both. To clearly describe such hardware and software interchanges, various exemplary components, blocks, modules, circuits, and operations have been generally described above in terms of their functionality. Whether such functionality is implemented in hardware or software depends on design requirements (or alternatively, design implementations) imposed on a specific application and overall system. Those skilled in the art may implement the described functionality in various ways for each specific application; such implementations should not be construed as departing from the scope of the present disclosure.

In hardware implementations, processing units used to perform the techniques may be implemented in one or a combination of ASICs, DSPs, digital signal processing devices (DSPDs), PLDs, FPGAS, processors, controllers, microcontrollers, microprocessors, electronic devices, other electronic units designed to perform the functions described in the present disclosure, computers, or combinations thereof.

Accordingly, various exemplary logical blocks, modules, and circuits described in connection with the present disclosure may be implemented or performed by a general-purpose processor, a DSP, an ASIC, an FPGA or another programmable logic device, discrete gate or transistor logic, discrete hardware components, or any combination designed to perform the functions described herein. A general-purpose processor may be a microprocessor, but in the alternative, the processor may be any conventional processor, controller, microcontroller, or state machine. The processor may also be implemented by a combination of computing devices, for example, a combination of a DSP and a microprocessor, a combination of multiple microprocessors, a combination of one or more microprocessors coupled with a DSP core, or any other configuration.

In a firmware and/or software implementation, the techniques may be implemented as instructions stored on computer-readable media such as RAM, ROM, NVRAM, PROM, EPROM, EEPROM, flash memory, a compact disc, or magnetic or marking data storage devices. The instructions may be executable by one or more processors, causing the processor(s) to perform certain aspects of the functions described in the present disclosure.

When implemented in software, the described techniques may be stored or transmitted as one or more instructions or code on a non-transitory computer-readable medium. Computer-readable media include both computer storage media and communication media, including any medium that facilitates transfer of a computer program from one place to another. Storage media may be any available media that may be accessed by a computer. Non-limiting examples of computer-readable media include RAM, ROM, EEPROM, CD-ROM or other optical disk storage, magnetic disk storage or other magnetic storage devices, or any other medium that may be used to store desired program code in the form of instructions or data structures and that may be accessed by a computer. Any connection may also be properly termed a computer-readable medium.

For example, when software is transmitted from a remote source such as a website, a server, or another remote source using coaxial cable, fiber-optic cable, twisted-pair, digital subscriber line (DSL), or wireless technologies such as infrared, radio, and microwave, the coaxial cable, fiber-optic cable, twisted-pair, DSL, or wireless technologies such as infrared, radio, and microwave are included in the definition of medium. Disks and discs, as used herein, include compact discs (CDs), laser discs, optical discs, digital versatile discs (DVDs), floppy disks, and Blu-ray discs; disks normally reproduce data magnetically, while discs reproduce data optically with lasers. The above combinations should also be included within the scope of computer-readable media.

Software modules may reside in RAM, flash memory, ROM, EPROM, EEPROM, registers, a hard disk, a removable disk, a CD-ROM, or any other form of storage medium known in the art. An exemplary storage medium may be coupled to a processor such that the processor may read information from and write information to the storage medium. Alternatively, the storage medium may be integrated into the processor. The processor and the storage medium may reside within an ASIC. The ASIC may reside in a user terminal. Alternatively, the processor and the storage medium may reside as discrete components in a user terminal.

Although the above-described examples are described as utilizing one or more standalone computer systems, aspects of the present disclosure are not limited thereto and may be implemented in conjunction with any computing environment such as a network or distributed computing environment. Furthermore, aspects of the subject matter described herein may be implemented on multiple processing chips or devices, and storage may likewise be affected across multiple devices. Such devices may include PCs, network servers, and portable devices.

Although the present disclosure has been described with reference to some example embodiments, various modifications and changes may be made within the scope of the present disclosure by those skilled in the art. Such modifications and changes should be considered as falling within the scope of the claims attached hereto.

What is claimed is:

1. A call voice data processing method performed by at least one processor, the call voice data processing method comprising:
converting first voice data into first text, the first voice data corresponding to a real-time call;
first displaying the first text and first speaker information on a first screen, the first speaker information corresponding to a speaker of the first voice data; and
second displaying second text and second speaker information on the first screen in response to receiving a first user input, the second text corresponding to second voice data associated with a first time point, the second voice data corresponding to the real-time call, the first time point being earlier than a current time by a first duration, and the second speaker information corresponding to a speaker of the second voice data.

2. The call voice data processing method as claimed in claim 1, wherein the second displaying comprises:
displaying information regarding the first time point together with the second text and the second speaker information on the first screen.

3. The call voice data processing method as claimed in claim 1, wherein the first user input comprises:
an input selecting a first object displayed on the first screen; or
an input scrolling on the first screen in a first direction.

4. The call voice data processing method as claimed in claim 3, further comprising:
displaying third text and third speaker information on the first screen in response to receiving a second user input, the third text corresponding to third voice data associated with a second time point, the second time point being later than the first time point, the third voice data corresponding to the real-time call, and the third speaker information corresponding to a speaker of the third voice data.

5. The call voice data processing method as claimed in claim 3, further comprising:
third displaying third text and third speaker information based on satisfaction of at least one condition, the third text corresponding to third voice data associated with the current time, the third voice data corresponding to the real-time call, the third speaker information corresponding to a speaker of the of the third voice data, and the at least one condition includes,
passage of a second duration from the second displaying, or
receiving a second user input.

6. The call voice data processing method as claimed in claim 5, wherein the second user input comprises:
an input selecting a second object displayed on the first screen; or
an input scrolling on the first screen to an endpoint in a second direction opposite to the first direction.

7. The call voice data processing method as claimed in claim 1, further comprising:
translating the first text into a first language set for a user based on a language set for the speaker of the first voice data differs from a language set for a recipient of the first voice data.

8. The call voice data processing method as claimed in claim 1, wherein
the second displaying comprises displaying the second text and the second speaker information in a first area of the first screen; and
the call voice data processing method further comprises displaying third text and third speaker information in a second area of the first screen in response to receiving third voice data during the second displaying, the third text corresponding to the third voice data, the third voice data corresponding to the real-time call, the third speaker information corresponding to a speaker of the third voice data, and the second area being different from the first area.

9. The call voice data processing method as claimed in claim 1, further comprising:
storing first log information of the real-time call based on the first text and the first speaker information.

10. The call voice data processing method as claimed in claim 9, wherein the storing comprises storing the first text the first speaker information after termination of the real-time call or in response to receiving a second user input.

11. The call voice data processing method as claimed in claim 9, wherein the storing comprises storing information regarding a time point of the first voice data along with the first text and the first speaker information.

12. The call voice data processing method as claimed in claim 9, further comprising:
displaying the first log information on a second screen different from the first screen.

13. The call voice data processing method as claimed in claim 12, further comprising:
displaying a third screen immediately after termination of the real-time call, the third screen including an object,
wherein the displaying the first log information comprises displaying the first log information in response to receiving a second user input, the second user input including selection of the object.

14. The call voice data processing method as claimed in claim 12, further comprising:
displaying a subset of the first text differently from a remainder of the first text within the first log information displayed on the second screen in response to receiving a second user input selecting the subset of the first text.

15. The call voice data processing method as claimed in claim 9, further comprising:
determining whether a first user has subscribed to a first service,
wherein the storing is performed in response to determining the first user has subscribed to the first service.

16. The call voice data processing method as claimed in claim 15, further comprising:
transmitting the first log information to an external electronic device in response to receiving a second user input.

17. The call voice data processing method as claimed in claim 15, further comprising:
determining whether a second user of an external electronic device has subscribed to the first service; and
determining whether to transmit the first log information to the external electronic device based on whether the second user has subscribed to the first service.

18. The call voice data processing method as claimed in claim 17, further comprising:
transmitting second log information to the external electronic device in response to determining the second user has not subscribed to the first service, the second log information including,
a portion of the first log information, or
information from the first log information converted into another format.

19. A non-transitory computer-readable storage medium storing computer-readable instructions that, when executed by at least one processor, cause the at least one processor to:
convert first voice data into first text, the first voice data corresponding to a real-time call;
display the first text and first speaker information on a first screen of a display, the first speaker information corresponding to a speaker of the first voice data; and
display second text and second speaker information on the first screen in response to receiving a first user input, the second text corresponding to second voice data associated with a first time point, the second voice data corresponding to the real-time call, the first time point being earlier than a current time by a first duration, and the second speaker information corresponding to a speaker of the second voice data.

20. An electronic device comprising:
a display;
memory; and
at least one processor connected to the display and the memory, the at least one processor being configured to execute computer-readable instructions stored in the memory to cause the electronic device to,
convert first voice data into first text, the first voice data corresponding to a real-time call,
display the first text and first speaker information on a first screen of the display, the first speaker information corresponding to a speaker of the first voice data, and
display second text and second speaker information on the first screen in response to receiving a first user input, the second text corresponding to second voice data associated with a first time point, the second voice data corresponding to the real-time call, the first time point being earlier than a current time by a first duration, and the second speaker information corresponding to a speaker of the second voice data.
